(19) United States
(12) Patent Application Publication
(10) Pub. No.: US 2026/0079054 A1
(43) Pub. Date: Mar. 19, 2026

(54) DEVICE FOR VISUALLY INDICATING EXCESS TEMPERATURE AND METHOD FOR MANUFACTURING SAME

(71) Applicant: OBSHCHESTVO S OGRANICHENNOI OTVETSTVENNOSTIU "TERMOELEKTRIKA", Moscow (RU)

(72) Inventors: Aleksei Valerevich LESIV, g. Dolgoprudnyi (RU); Stanislav Anatolevich AMELICHEV, g. Balashikha (RU); Elizaveta Alekseevna GERASIMCHUK, g. Moskva (RU); Ekaterina Aleksandrovna KNIAZEVA, g. Moskva (RU)

(21) Appl. No.: 19/109,472

(22) PCT Filed: Oct. 3, 2022
(86) PCT No.: PCT/RU2022/000301

§ 371 Date: Mar. 6, 2025

(30) Foreign Application Priority Data
Sep. 6, 2022 (RU) 2022123752

(51) Int. Cl. G01K 11/18; G01K 11/06

(52) U.S. Cl. CPC G01K 11/18; G01K 11/06

(57) ABSTRACT

The invention relates to devices for visually recording the fact of excess of temperature, namely to devices for recording the fact of excess of temperature above at least one threshold value, the operating principle of which is to change the microstructure of a heat-sensitive material at given threshold temperature values, accompanied by an irreversible visual effect, as well as variants of the method for manufacturing this device. The device for visually recording the excess of temperature above at least one threshold value, having a layered structure including: —a base that is non-transparent to at least part of visible light, on the front surface of which inscriptions are applied indicating at least one numerical threshold temperature value; —at least one temperature-sensitive material that is non-transparent to at least part of visible light, applied to individual sections of the base, the microstructure of which includes particles of solid organic substance and voids filled with the gas phase; —a transparent protective layer that partially or completely covers the front surface of the device. In this case, the device is designed with the ability to irreversibly change its appearance upon reaching at least one threshold temperature indicated on it due to the destruction of the microstructure of the corresponding heat-sensitive material, accompanied by the fusion of particles of solid organic substance, a decrease in the fraction of voids and an increase in its transparency with the development of the color of the base. Variants of a method for manufacturing the device for visually recording the excess of temperature above at least one threshold value are also disclosed. The group of inventions provides for an increase in the reliability and accuracy of visually recording the fact that the temperature has exceeded at least one threshold value, the impossibility of returning the heat-sensitive material to its original state, an increase in the operating speed of the heat-sensitive material, including under conditions of short-term peak loads of controlled equipment elements or emergency operating modes, as well as an increase in the safety of operation of both the controlled equipment and the recording device itself throughout its entire service life.

### FIELD OF TECHNOLOGY TO WHICH THE GROUP OF INVENTIONS RELATES

The group of inventions relates to devices for visually recording the fact that the temperature has exceeded at least one threshold value, the operating principle of which is to change the microstructure of a heat-sensitive material at given threshold temperature values, accompanied by an irreversible visual effect, as well as to variants of the method for manufacturing this device.

### STATE OF THE ART

An increase in temperature is one of the first and most common signs of developing defects in various equipment, such as an increase in transient contact resistance in the electrical power industry, malfunctions of bearings in mechanics, interturn short circuits in the windings of electric motors, failure of chargers or batteries in household appliances. Timely detection of such overheating makes it possible to eliminate the malfunction in advance and prevent equipment failure, emergency situations and associated fires or shutdowns. Technical and regulatory documents establish maximum permissible temperatures, heating above which should be considered a defect requiring immediate cessation of operation and removal of equipment for repair (for example, RD 34.45-51.300-97, RD 153-34.0-20.363-99, GOST 8865-93, 8024-90, 10693-81, 2213-79, 10434-82, 16708-84, 2585-81, 32397-2020, 26346-84, 839-2019, GOST R 51321.1-2007, etc.).

Various diagnostic methods are used to identify defects associated with exceeding maximum permissible temperatures. The most widely used method of thermal diagnostics is thermal imaging system. However, thermal imaging diagnostics has a fundamental limitation due to the fact that it can only be used to see the thermal image at the time of inspection. Since the heating of equipment, in most cases, is directly related to its load, the most informative and reliable diagnostics is at the moment of peak load (at rated or starting currents, maximum speed, etc.). It is recommended to create special loading modes for equipment, mechanisms and units in accordance with the guidelines for thermal imaging diagnostics. In addition, most modern equipment does not allow inspection under load due to design features or safety requirements. Thus, the detection rate of defects using thermal imaging devices is low.

The electronic devices are used for automatic continuous temperature monitoring, for example, thermoelectric converters (thermocouples), pyrometers and other sensors with a special recording device, or various overheating indicators. A feature of electronic sensors is that they measure temperature only at the point of contact between the sensor and the device. This does not allow the detection of local defects that occur in a separate section of a large surface, for example, interturn short circuits of transformers or the occurrence of partial discharges in the sheath of cables or cable couplings. In this case, a small section of the outer insulation of the cable, having an area of several square millimeters, is heated. It is impossible to see such heating, for example, with a thermocouple fixed just a few centimeters from the defect or laid inside the cable. In addition, electronic sensors have a complex design, require a power supply, and do not allow measuring the temperature of moving parts or sections of an electrical circuit under high voltage.

Other means of continuous monitoring of overheating include chemical or mechanical temperature indicators, which can be of two types: reversible (changing appearance only when heated and returning it when cooled) and irreversible (changing appearance after exceeding a given temperature and maintaining it after cooling). An example of reversible devices is the invention described in document U.S. Pat. No. 7,600,912B2 (publication date 20 Mar. 2007) and which is a single-layer or two-layer sticker, the heat-sensitive element of which contains leuco dyes and a developer in a binder. When a certain temperature is reached, the binder melts and the developer reacts with the dye, coloring the label. After lowering the temperature, the dye crystallizes and the color is restored. An inorganic reversible temperature indicator based on a chromium (III) complex compound is described in document RU2561737C1 (publication date 12 Sep. 2014). The proposed thermochromic material has the ability to reversibly change color when heated above a temperature of 120° C. A feature of this kind of invention is the need to visually record heating at the moment the temperature is exceeded without the ability to detect defects outside of peak loads, so these devices are not widely used.

Unlike reversible indicators, irreversible indicators allow not only to identify, but also to record the fact that a threshold temperature has been exceeded. Moreover, unlike a thermal imaging device or reversible indicators, inspection of such stickers can be carried out without creating a maximum load mode and even on equipment taken out for repair.

Irreversible heating indicators can be classified according to their operating principle. Indicators are known that are based on the mechanical destruction of a heat-sensitive element, on the chemical reaction of the components of the composition, or on the phase transition of a heat-sensitive component.

An example of a temperature indicator based on mechanical destruction is described in the source [U.S. Pat. No. 6,176,197B1, publication date 2 Nov. 1998], according to which the temperature indicator is a closed hollow transparent elongated tube with two compositions of different colors, isolated from each other by a polymer partition having a melting temperature close to the melting temperatures of the compositions. When a given threshold temperature is reached, the partition is destroyed, the compositions melt and mix, as a result of which the color of the contents of the tube changes. The features of the invention include the impossibility of monitoring the overheating of the entire surface, low operating speed, since, to complete the color transition, it is necessary not only to completely melt the indicator composition and the polymer membrane separating them, but also the time for mixing the resulting liquid phases, which may be difficult due to insufficiently fast diffusion processes nearby melting point. In addition, the design features of the described invention do not allow creating a flexible device that fits tightly to the entire surface to be monitored.

The chemical reaction of etching a metal substrate with an activator, which begins when a certain temperature is reached, is described in the patent [EP2288879B1, publication date 4 Jun. 2008]. The indicator changes color from silvery-white or mirror-like to colorless and can be used to monitor temperature in food, medical, and electrical equipment. The metal layer and the activator layer can be applied to a thin film made in the form of a sticker, which ensures the flexibility of the product and the ability to be attached to various surfaces. Another example of a temperature indicator based on chemical interaction is the invention described in the source [U.S. Pat. No. 6,957,623B2, publication date 9 Mar. 2004]. The heat-sensitive material in this case contains a mixture of water, latex and ice-forming active microorganisms and is transparent until a threshold temperature is reached. When heated to a given temperature, latex and ice-forming active microorganisms interact with each other to form a non-transparent material. Among the commercially available indicators, the operating principle of which is based on the occurrence of a chemical reaction, we can highlight the indicator of the Retomark model, supplied by YALOS Innovation Company LLC (https://www.yalosindicator.com/product/termoindikatory-kontrol-temperatury).

The presented irreversible thermal indicators, the operating principle of which is based on chemical reactions, are characterized by low accuracy, since the degree of occurrence of a chemical reaction is determined not only by temperature, but also by time in accordance with the Arrhenius equation. Therefore, prolonged exposure of the composition to a temperature slightly lower than the threshold value will also lead to the product operation. At the same time, the above standards regulate specific threshold temperature values with an interval of no more than 5° C., which makes the described inventions unsuitable for identifying defects. Another feature of such devices is the presence of a pronounced dependence of the operating time on temperature: with short-term heating to a threshold value, the chemical reaction may not be completed and a change in the color of the indicator either will not occur or will be insufficient for detection. In addition, due to the reversibility of color transition reactions, the appearance of some products returns to their original state after prolonged exposure at low temperatures.

The most accurate temperature indicators are those based on a phase transition, namely, on the melting of a heat-sensitive component. Since, unlike a chemical reaction, the temperature of the phase transition does not depend on the exposure time, such indicators have the greatest accuracy and are capable of maintaining their original appearance indefinitely at a temperature slightly lower than the threshold.

Irreversible indicators based on the principle of phase transition of a heat-sensitive component can be made in the form of stickers or paints. The use of temperature indicator paints and varnishes, the operating principle of which is based on the melting of the pigment, is described in a number of documents, including, for example, CN112322134A (publication date 23 Sep. 2020), CN111849346A (date publication 11 Jul. 2020), CN108610694A (date of publication 9 Dec. 2016), SU1765145A1 (date of receipt 30 Oct. 1989), SU576334A1 (date of publication 25 May 1976). Typically, such paints consist of synthetic resins, fillers and fusible components dispersed in water or a solvent. When heated above a given temperature, the heat-sensitive component melts, which leads to a change in the color of the composition due to a change in the refractive index. As a rule, after cooling, the color of such compositions does not change or changes slightly, which makes it easy to record the fact of overheating during visual inspection. The large area that can be covered using heat-sensitive paint allows you to localize the exact location of the temperature rise. Another advantage of such indicators is the ability to apply them to surfaces of any shape and size.

However, indicator paints have a number of features, which include:
You cannot indicate the temperature on the paint. During a visual inspection of the equipment, the operator can only see the fact that the temperature has been exceeded, but cannot determine the numerical value of the exceeded threshold. To do this, you need to make special notes. The absence of such entries may result in an error.
flow of indicator paint when the threshold temperature is exceeded. Under the influence of temperature after melting a heat-sensitive component, the paint becomes less viscous and can flow from the surface onto open conductive elements of an electrical installation or moving parts of mechanisms, which can lead to short circuits, loss of electrical strength, heating, jamming, fires and other accidents.
the impossibility of determining the temperature with high accuracy, since the paint is applied to the surface in a non-uniform layer. This is especially true for elements with complex surface geometry. As a result, sections with a thicker layer of paint will take longer to warm up, and the difference between the surface temperature and the phase transition (operation) temperature will be greater than in sections with a thinner layer.
low adhesion and difficulty in applying paint to wires made of non-adhesive materials (silicone, polyethylene, fluoroplastic). A large amount of hot-melt pigment required for clear visualization of overheating, as a rule, leads to a decrease in the proportion of polymer binder in the composition and reduces paint adhesion. This leads to the fact that the composition easily peels off under mechanical stress.
dependence of the paint operating temperature on the chemical coating of the surface. Because the paint comes into direct contact with the material it is applied to, such as cable insulation or engine body paint, various substances, primarily flame retardants and plasticizers, can be extracted into the paint. Such substances can lead to the formation of eutectic mixtures with a hot melt component or otherwise affect the phase transition temperature.

Another feature of the inventions presented above is their limited ability to operate under conditions of reduced pressure or vacuum due to the sublimation of basic substances. The sources SU867919A1 (publication date 30 Sep. 1981), SU401214A1 (publication date 8 May 1976) describe thermosensitive compositions intended for visual and photographic determination of the surface temperature of bodies at atmospheric pressure and in vacuum up to 10-4 mm Hg. Mixtures of heat-sensitive components are disclosed in them, in the role of which salts or esters of higher carboxylic acids, a binder and ethyl alcohol are used. Alcohol solutions of BF-2 or BF-4 adhesives are used as binders. However, their execution is offered only in the form of thermal paints, the general disadvantages of which are given above.

These problems are absent with special indicator devices (such as stickers, cambrics, clips, etc.), in which a hot-melt composition is factory-applied evenly, in a thin layer, onto a base that ensures good adhesion to the required surface, and is additionally covered with a polymer film, which protects the hot-melt composition from mechanical or chemical influence and does not allow it to flow out when melted after operation.

Irreversible heat-sensitive devices can be made in single-temperature and multi-temperature versions. The advantage of irreversible multi-temperature indicator devices is that they make it possible to determine not only the fact that a given temperature has been exceeded, but also to determine the numerical value of the maximum surface temperature to which the controlled element was heated during operation, as well as to track the dynamics of the development of the defect, and provide the ability to compare overheating temperatures of identical elements (equipment units). Single-temperature indicator devices make it possible to clearly record the excess of the maximum permissible temperature regulated for controlled electrical devices and electrical installation components, thereby providing timely notification of the personnel conducting the inspection about the occurrence of an emergency or pre-emergency situation and the ability to promptly respond to eliminate possible consequences.

As substances used as a heat-sensitive component in such indicators, higher carboxylic acids and their salts, paraffins, waxes, esters of polyhydric alcohols, complex compounds of transition metals, metal alloys and other compounds are usually used.

Heat-sensitive devices known from the prior art, based on the phase transition of a hot-melt component, can be classified according to the operating principle that provides a change in the color of the device: a change in the transparency of the hot-melt component during melting or the dissolution of dyes in the melt. Among the inventions containing dyes, a heat-sensitive material is known in which the dye is uniformly distributed in a solid polymer binder (WO2018176266A1, publication date 4 Oct. 2018). When the material is heated to the melting point of the binder, the dye dissolves in it, changing its color. Waxes, low-melting polymers, non-polymeric organic substances (vanillin or triphenylphosphine) or mixtures thereof are used as polymer binders. The material according to the invention U.S. Pat. No. 6,602,594B2, publication date 5 Aug. 2003, is constructed in a similar way, in which the granular or powdered dye in the original state is mixed with a hot-melt substance and is able to diffuse into it by dispersing or dissolving when a given temperature is reached. Derivatives of fatty acids, alcohols, ethers, aldehydes, ketones, amines, amides, nitriles, hydrocarbons, thiols and sulfides are used as hot-melt components. The features of the proposed methods include an insufficiently contrasting color transition, since the dye in the solid binder also gives it the appropriate color, as well as coagulation of dye particles during cooling in some products, which leads to the return of the original color upon cooling.

A number of inventions are based on the penetration of a hot-melt component into the base material, which results in a change in the color of the device. Waxes applied to a colored paper substrate become transparent when they reach the melting point and permeate the paper substrate, revealing its color (US20060011124A1, publication date 15 Jul. 2004). Another variant is a device consisting of a non-transparent porous membrane and an amorphous polymer or colored composite layer applied to the bottom layer of this membrane, comprising a polymer binder, a crystalline material and a dye (U.S. Pat. No. 4,428,321A, publication date 16 Nov. 1981; WO2019090472A1, publication date 7 Nov. 2017). As the temperature rises, the heat-sensitive material melts and penetrates into the porous membrane, causing it to become transparent due to the same refractive index of the material and the membrane. A distinctive feature of devices of this type is the crystallization of the material in the pores of the membrane or base, due to which it can lose transparency and, as a result, the color indication will be impaired.

The invention is known from the prior art, described in source WO2018176266A1 (publication date 14 Oct. 2018) and is a thermal indicator composition containing an organic solid material having a melting temperature above ambient temperature, and a dye that is in contact with the organic solid material and is able to dissolve in organic solid material when heated to the melting temperature of the organic solid material. In this case, the organic solid material is presented in the form of a continuous phase in which dye particles are distributed in the form of clusters or crystals. When the device reaches the melting temperature of an organic solid material, this material melts, as a result of which the dye particles dissolve in the molten material, thereby coloring the entire volume of the material in the color corresponding to the dye. In some variants of the invention, the indicator composition is applied to a substrate containing grooves and depressions. When an organic solid material melts and the dye dissolves in it, not only the color of the indicator layer changes, but also the material penetrates into the grooves and depressions of the substrate, with the appearance of the corresponding pattern. In another variant of the invention, the device is made by layer-by-layer application of an organic solid material with a layer thickness of 1-25 microns, a dye with a layer thickness of 0.1-0.5 microns and additional layers that provide the necessary performance characteristics: adhesion of the device to the surface, protection of the device from external influences, including from UV radiation. However, the described invention has a number of features, such as low contrast of the color transition when the melting temperature is reached, low accuracy of operation of the indicator composition if the temperature of the device does not exceed the melting point of the organic material, as well as the need to select a combination of dye and solid organic material that provides maximum solubility and formation of a colored solution. Besides, the source does not indicate how irreversibly the color change occurs when the device is cooled to a temperature below the melting point of the organic material.

Some commercial devices are based on the principle of changing the color of the hot-melt component itself without the use of additional dye, which are stickers with a layer of a heat-sensitive substance applied to them, which, when a given temperature is reached, melts and changes transparency, without the penetration of the molten substance into the pores of the base. The closest analogues of the proposed group of inventions are temperature indicator elements produced and/or supplied by such companies as YALOS Innovation Company LLC, Lyuminofor NPF CJSC.

The prototype of the claimed device is temperature indicator stickers produced by the Japanese company NiGK Corporation (https://content.bownow.jp/files/index/sid_9c257787049ca562bbda?client_id=d867dc3c-ab2f-4a08-ba4a: 32d9c6b2c5a1&access_token=&referer=https%3A%2F%2Fwww.nichigi.co.jp%2Fen%2Fen_downloadform%Fen_data.html, catalog dedicated to temperature indicator materials). It discloses a number of irreversible indicator stickers (for example, LE, 3E, 4E, 5E, 8E, F, 1K, 3K, 3R, 5S, Mini series), on a colored base of which a heat-sensitive material is applied. High accuracy of temperature determination is achieved by using the effect of changing the transparency of purified stable pigment when it reaches its melting point, and visibility is achieved by developing the color of the base. Moreover, the indicators, as stated in the catalog, are irreversible and do not return to their original color after operation. The validity period of stickers of the LE, 3E, 4E, 5E, 8E, F series indoors is 5 years, outdoors-3 years, and for stickers of the 1K, 3K, 3R, 5S, Mini series-indoors 3 years, outdoors they are not applicable.

These indicator stickers have a number of features that significantly limit their mass use:
insufficient service life of the sticker, since it is extremely important that the service life of devices for recording the fact of exceeding temperatures is equal to or greater than the service life of the equipment on which they are installed, since access to some electrical installation units during operation may be excluded, and the attachment of heat-sensitive elements to such units must occur at the stage of assembly or repair work;
the need to attach stickers only to a flat surface, since attachment to curved surfaces or corners can lead to inaccurate operation of the device, which the manufacturer warns about on page 2 of the catalog. This indicates insufficient flexibility of both the sticker base and the layer of heat-sensitive material, the attachment of which to surfaces of complex shape can lead to the formation of cracks and detachment of the composition layer from the base, as well as uneven heating of the heat-sensitive material, which will also reduce the accuracy of overheating registration;
low reliability of the device operation, since there is a possibility of loss of non-transparency of the composition during its service life, especially when stickers with a threshold temperature of more than 130° C. are exposed to high temperatures, which the manufacturer warns about on page 2 of the catalog, as well as partial return of non-transparency after device operation.

These features are due to the following.

In order to ensure maximum non-transparency of the heat-sensitive layer and keep the color of the painted base in its original state invisible, it is necessary that the heat-sensitive material have high light absorption and scattering coefficients. Such properties are possessed by materials that contain multiple phase boundaries, upon which light is scattered in different directions. In devices known from the prior art, the creation of a large area of phase boundaries is achieved by distributing crystals of a hot-melt component in a binder, that is, a “solid-in-solid”system. Light falling on a material of such a structure is reflected from numerous crystal faces, scattered and does not reach the colored base, which makes it invisible and the material non-transparent. When melting, solid crystals change their phase state, become liquid and, thereby, take the form of spherical droplets, which reduces the total area of the phase boundaries and makes the material non-transparent. Further cooling leads to the fact that the hot-melt component also solidifies in the form of spheres and the transparency of the material is maintained.

However, over time, processes can occur in such materials, as a result of which their performance characteristics are significantly reduced:
solid solutions with a polymer binder can form on the surface of the crystals due to the penetration of binder molecules into the crystal lattice of the heat-sensitive component. This will lead to smoothing of the crystal boundaries, a decrease in the area of the phase boundaries and, as a result, an increase in the transparency of the material and the risk of false detection of overheating;
possible recrystallization due to partial dissolution of crystals in the binder, as a result of which the crystals will become larger, which will also lead to a decrease in the number of phase boundaries and a decrease in non-transparency;
when solid solutions are formed at the phase boundaries, solid eutectic mixtures can arise that have a lower melting point than each of the components separately. This will lead to a change in the device's operating temperature and will reduce the accuracy of recording the fact that the temperature has been exceeded.

The processes listed above can be significantly accelerated when devices are operated at temperatures slightly below threshold values, especially for stickers with high threshold temperatures. As a result, the service life of such devices will be greatly reduced even relative to the values claimed in the prototype, as stated by the manufacturers.

The need to use a relatively large layer of heat-sensitive component can also lead to:
insufficient flexibility of the devices shown in the prototype;
cause excess thermal composition to flow onto sections of the controlled surface, which is unacceptable during the operation of electrical equipment;
uneven heating of the entire volume of the substance and a large difference in values between the temperature of the controlled surface and the upper layer of the material, which is especially noticeable when recording short-term overheating.

As a result, even if the bottom layer of the heat-sensitive component, located closer to the heated surface, melts and changes color, the outer layer may remain in its original state. This will disrupt the accuracy of recording the fact of exceeding temperatures and reduce the overall safety of equipment operation.

It should also be noted that when threshold temperatures are reached, the crystals of the heat-sensitive component melt to form spherical droplets, which, when heated for a sufficiently long time above the device's operating temperature, can diffuse in the polymer binder, sticking together and forming droplets of larger size. When the operated device cools, these enlarged spherical droplets solidify, whose total surface area, which constitutes the phase boundary area, will be significantly lower than in the original material. This will ensure the transparency of the material after cooling. However, if the device detects short-term heating, during which the crystals of the heat-sensitive component melt, but diffusion does not have time to occur due to the low speed of diffusion processes in solids and viscous liquids, then sticking and enlargement of droplets will not occur. As a result, when the device cools, a large number of individual small spherical droplets will be observed in the material, whose surface area, and hence the total area of the phase boundaries, will be slightly lower than that of the material in its original state before heating. This can lead to a reverse color transition after operation, especially when cooled or exposed for a long time at a temperature below the melting point of the heat-sensitive component, a violation of the contrast of the color change, and a false negative result.

Thus, there is a need to create a device that has high reliability of visual registration of temperature exceeding threshold values, high operating speed and operational safety over the entire service life and methods of its manufacture.

### Terms and Definitions Used in this Group of Inventions

The term “non-transparent to at least part of visible light” refers to a material that does not transmit all or part of light in the visible range (380-760 nm).

“Microstructure” is the spatial arrangement of particles or individual phases of a material, 1-100 microns in size, reflecting the shapes and orientation of the particles that make up the material. Unlike chemical structure or nanoparticles, microstructure determines only the physical, optical and mechanical properties of the material, but does not affect the chemical properties of the substances that make up the microstructure. In relation to the present invention, “irreversible change in microstructure” means an irreversible change in the physical, optical or mechanical properties of a material relative to the original state, accompanied by a change in its microstructure, that is, the spatial arrangement of particles or individual phases of the material, their size or shape, up to the complete fusion of particles and formation of a single phase.

The term “continuous solid phase” reveals a material structure containing particles of a solid substance of arbitrary shape, each of which has at least one point, face or edge in contact with an adjacent particle and interconnected in such a way that each element of the solid phase can be connected to another element by a single broken line, each point of which is located inside this phase. In this case, the microstructure is not a continuous solid phase only if such a curve cannot be constructed. Depending on the shape and size of the solid particles, the continuous solid phase may have a cellular, granular, fibrous, crystalline or scaly structure.

The term “continuous gas phase” refers to the voids within a solid that communicate with each other through pores or channels.

The term “flexible base” refers to materials that have the ability to change their shape under external influences in such a way that, after returning to their original form, their functional properties remain the same.

The term “threshold temperature value” or “threshold temperature” (T) refers to the numerical value of temperature at which a sharp change in the appearance of a heat-sensitive material occurs, for example, a partial change in color due to an increase in the transparency of one of the layers. In this group of inventions, the accuracy of recording exceeding the threshold temperature is no more than 5° C.

The term “accuracy of recording the excess of the threshold temperature” means the following:
1. Until the device reaches a temperature equal to the threshold temperature of the corresponding heat-sensitive material minus the value of the declared accuracy, there is no change in the transparency of the corresponding heat-sensitive material and the appearance of the device.
2. At a temperature equal to or greater than the threshold temperature of the corresponding heat-sensitive material plus the value of the declared accuracy, the corresponding heat-sensitive material is transparent and the device has a different appearance from the original one.
3. The exact value of the phase transition of the heat-sensitive component is within the declared range and is not further established. The accuracy of recording the excess of the threshold temperature determined by this group of inventions is 5° C.

The term “hiding power” refers to the ability of a material to cover the color of the surface on which it was applied. In the case of application to the border of black and white sections, “hiding power” is understood as the ability of the material to reduce the contrast between the specified sections of the surface, up to the complete disappearance of the visual difference between the sections. In this invention, the hiding power (D) of a heat-sensitive material is measured using a method similar to that described in GOST 8784-75 (clause 1 Visual method for determining hiding power). The heat-sensitive material is applied to a pre-weighed glass plate using the method described below and dried to a constant weight. Weighings are carried out with the required accuracy. The number of layers of heat-sensitive material is determined individually for each experiment. The mass of the heat-sensitive material is calculated as the difference between the mass of the device and the mass of the glass plate. A glass plate with a heat-sensitive material is placed on a contrast plate or chessboard and observed in diffuse daylight to see whether the white and black fields are visible. It is believed that hiding power is achieved when the difference in lightness between the sections of the plate lying on the black and white fields completely disappears, and is calculated as the ratio of the mass of the heat-sensitive material, expressed in grams, to the area of the layer of heat-sensitive material applied to the glass plate, expressed in m².

“Apparent density” is the ratio of the mass of dry material to its total volume, including the volume of voids made in the material (according to GOST 2409-95). In relation to the present group of inventions, apparent density is determined as follows. A homogeneous piece containing a heat-sensitive element is cut out of the product. The mass and volume are determined with the required accuracy. Volume measurement can be carried out, for example, by measuring linear dimensions with the required accuracy. The product is then separated into layers so that the layer of heat-sensitive material can be removed, the layer of heat-sensitive material is mechanically removed, and the mass and volume of the remaining elements are measured. The mass and volume of the heat-sensitive material is calculated as the difference before and after removal of the heat-sensitive material. The apparent density is obtained by dividing the mass of the heat-sensitive material by its total volume.

The term “fraction of voids” in a heat-sensitive material means the ratio of the volume of the gas phase to the total volume of the heat-sensitive material, or the ratio of the area of the gas phase sections to the total area of the heat-sensitive material section in one of the cuts. In relation to the present group of inventions, the fraction of voids may be determined by one of the following methods. The first method is based on the use of scanning electron microscopy of the surface of a heat-sensitive material. To do this, a homogeneous section containing a heat-sensitive material is cut out of the finished product. The protective layer is then removed from this section to ensure the safety of the heat-sensitive material. A section of the heat-sensitive material without a protective layer is analyzed using a scanning electron microscope with software that allows the total outer surface area of the solid particles of the sample to be calculated in a given material environment. The area of the gas phase sections is calculated by subtracting the total surface area of the solid particles from the area of the analyzed section and dividing the resulting value by the area of the analyzed section, obtaining the fraction of voids of the heat-sensitive material in one of the cuts. Measurements are carried out on 5-7 sections of the material, calculating the average value of the fraction of voids, expressed in fractions. The second method is based on the use of X-ray microtomography. Sample preparation is carried out in a manner similar to the first method. A section of heat-sensitive material of known volume is analyzed using a laboratory digital X-ray tomograph with software that allows one to calculate the percentage of gas phase in a given volume of the sample. Measurements are carried out on 5-7 sections of the material, obtaining the average value of the fraction of voids, expressed as a percentage.

The term “blind principle” refers to a specific microstructure of a heat-sensitive material in which the solid particles are predominantly in the form of flakes oriented predominantly parallel or perpendicular to the base on which the heat-sensitive material is applied. “Open blind principle” means the arrangement of solid particles predominantly perpendicular to the base layer on which the heat-sensitive material is applied, as well as to the outer protective coating layer. At the same time, the microstructure of such a material does not ensure the covering power of the base color. The “closed blind principle” refers to the orientation of solid particles predominantly parallel to the base layer and the protective coating layer. This microstructure of the heat-sensitive material provides greater covering power of the base color with the same layer thickness.

In this group of inventions, the term “glazing” is used, denoting the process of forming a uniform layer of one thermodynamic phase around a particle of another thermodynamic phase.

“Phase transition” is the transition of a substance from one thermodynamic phase to another when external conditions change. In relation to the present group of inventions, a phase transition can be a melting or other process accompanied by the transition of a substance from a solid to a fluid state when heated above a given temperature.

The term “completely insulating from the environment” means the creation of a protective layer that ensures the hermetic seal of the device, as well as prevents the communication of the heat-sensitive material with the environment and ensures the protection of the device from adverse external influences, including moisture, precipitation, splashes, industrial pollutants, mechanical impact, etc. The “partially insulating from the environment” layer also prevents the influence of adverse external factors on the device and thereby provides its protection, but does not create the hermetic seal of the device and maintains the atmospheric pressure of the gas phase in the volume of the heat-sensitive material.

### The Essence of the Group of Inventions

The objective of the claimed group of inventions is to create a device that increases the safety of operation of various equipment for reliable, accurate and safe recording of short-term and long-term temperature rises above at least one threshold value, as well as variants of the method of its manufacture.

Most specifically, the claimed group of inventions was created to solve the following problems:
1. Reliably visually recording the fact that the temperature of individual local sections or the entire surface has exceeded at least one threshold temperature value;
2. Increasing the reliability of detection of overheating recorded by the device for a long time after operation under conditions of actual operation of the device and equipment;
3. Providing the possibility of recording short-term overheating to detect defects that arise, for example, during the short-term flow of short-circuit currents or impulse overvoltages;
4. Ensuring the general safety of operation of various equipment having a device for visually recording excess temperature.

The technical result of the claimed group of inventions consists in increasing the reliability and accuracy of visually recording the fact that the temperature has exceeded at least one threshold value, the impossibility of returning the heat-sensitive material to its original state, increasing the operating speed of the heat-sensitive material, including under conditions of short-term peak loads of controlled equipment elements or emergency operating modes, as well as increasing the safety of operation of both the controlled equipment and the recording device itself throughout its entire service life.

The specified technical result in the first variant is achieved due to the layered structure of the device for visually recording excess of temperature above at least one threshold value, as well as the use of a heat-sensitive material having a special microstructure. In general, the device can be described as having a layered structure comprising:
a base that is non-transparent to at least part of visible light, on the front surface of which inscriptions are applied indicating at least one numerical threshold temperature value;
at least one heat-sensitive material that is non-transparent to at least part of visible light, applied to individual sections of the base, the microstructure of which includes particles of solid organic substance and voids filled with the gas phase;
a transparent protective layer that partially or completely covers the front surface of the device;
in this case, the device is designed with the ability to irreversibly change its appearance upon reaching at least one threshold temperature indicated on it due to the destruction of the microstructure of the corresponding heat-sensitive material, accompanied by the fusion of particles of solid organic substance, a decrease in the fraction of voids and an increase in its transparency with the development of the color of the base.

The use of a heat-sensitive material with voids, in comparison with the technical solutions presented in the prior art, makes it possible to increase the service life and increase the reliability of overheating determination, due to the impossibility of aggregation of solid particles through the gas phase, and to eliminate the possibility returning the material to its original state due to an irreversible change in the microstructure. When a heat-sensitive material containing voids is melted, an irreversible change in the original microstructure of the material occurs with an increase in the apparent density of the material and a decrease in the fraction of voids in it, associated with the fusion of particles of solid organic substance and with a decrease in the area of the solid-gas phase boundaries, due to the irreversible release gas contained in voids onto the surface and separation of gas and non-gas media. As a result, upon further cooling, the solid organic substance crystallizes without voids, thereby irreversibly changing the transparency (increasing relative to the original state) of the material for at least part of visible light, creating a visual effect of changing the appearance of the device with high contrast, which ensures high reliability of recording excess of temperature above the specified value.

Thus, the device proposed in the group of inventions is characterized by a complex operating principle, which consists not only in melting a heat-sensitive material, but also in an irreversible change in the microstructure due to separation of phases, fusion of particles of solid organic substance and reduction of the fraction of voids in the material, which ensures the impossibility of returning the material to its original state after subsequent cooling. Moreover, this change is irreversible even after a long time, when the material is exposed to low temperatures and temperature changes.

In studies of heat-sensitive materials with different fractions of voids, it was found that increasing the fraction of voids allows a significant reduction in the thickness of the heat-sensitive material layer required to cover the base color, compared to the thickness of the material layer in which there are no voids, required to provide the same hiding power (see examples 11-12 on pp. 50-55 of this description). This is achieved due to the multiple refraction of light at the solid-gas surface boundary. In the product according to the present group of inventions, the hiding power of at least one heat-sensitive material is preferably no more than 50 g/m².

As a result, high hiding power makes it possible to produce devices of minimal thickness that require minimal heat input to change color, that is, rapid and uniform heating of the material and its transfer into melt is ensured, which increases the operating speed of the heat-sensitive material and makes it possible to record overheating with minimal values of temperature excess relative to a threshold value or with a minimum exposure time, in particular, makes it possible to record overheating even under conditions of short-term peak loads of controlled units or during emergency operating modes. In addition, the minimum thickness of the product does not affect the performance, safety of operation and the necessary heat removal from the controlled product, while maintaining the flexibility of the base for its tight fit to surfaces of complex shape, avoiding cracks and peeling of the material from the base.

Also, reducing the thickness of the heat-sensitive material layer eliminates the flow of excess material during its melting, which can lead to short circuits, loss of electrical strength, heating, jamming, fires and other accidents.

In various variants of the invention, the pressure of the gas phase inside the voids of the heat-sensitive material may be equal to or less than atmospheric pressure. When using a device with sub-atmospheric pressure, the rate of irreversible change in the microstructure, and, as a result, the operating speed of the heat-sensitive material, is further increased by the application of force to the material created by atmospheric pressure acting on the material through a transparent protective layer.

The protective layer also provides protection from adverse external factors: moisture, precipitation, splashes, industrial pollutants, and mechanical impact. Preferably, the transparent protective layer covering the device is made of an elastic polymer material, which provides not only protection from environmental influences and the prevention of spreading and dripping of heat-sensitive compositions after operation, but also the hermetic seal of the device and maintenance of the gas pressure inside the voids below atmospheric pressure before heating. Also, the elasticity of the protective layer additionally makes it possible to install the device on a surface of complex shape while maintaining the functional characteristics of the device.

Due to the peculiarity of the structure of the heat-sensitive layer, the microstructure of which contains a large amount of the gas phase, when the threshold temperature is exceeded, an air bubble may form under the protective layer. If the pressure of the gas phase inside the voids of the heat-sensitive material is equal to atmospheric pressure, and the layer of the heat-sensitive material is covered with a transparent protective layer hermetically, when the microstructure of the heat-sensitive material is destroyed, separation of gas and non-gas media occurs. Since the process occurs when heated, the volume of the resulting bubble increases due to thermal expansion. As the device cools further, the volume of the gas medium decreases and the size of the bubble under the surface of the protective layer decreases. The processes described explain the need to use elastic materials in the manufacture of the device to maintain its integrity during operation over a wide temperature range. To remove a bubble that occurs when the threshold temperature is exceeded, according to some variants of the proposed invention, a gap may be made between the transparent protective layer and the base, or micro-holes may be made in the protective layer, providing, on the one hand, the possibility of escaping the gas released during operation, and on the other hand, the necessary protection of the heat-sensitive material from external influences.

In existing variants of the invention, with a gas pressure inside the voids of the heat-sensitive material below atmospheric pressure and a sealed protective coating, when the threshold temperature is exceeded and subsequent cooling occurs, the formation of a gas bubble under the protective layer may not be observed. This is due to the fact that the thermal expansion of the gas is compensated by the pressure of the gas phase inside the voids below atmospheric pressure in the original state.

Preferably, in the microstructure of at least one heat-sensitive material in the original state, the particles of solid organic substance are predominantly oriented parallel to the plane of the surface of the base and protective coating. In particular cases, solid organic substance can be presented in the form of flakes, fibers, their conglomerates, etc.

Preferably, the fraction of voids of at least one heat-sensitive material after heating above the corresponding threshold temperature value decreases by at least 2 times relative to the original state, which further increases the contrast of the color transition of the device when the threshold temperature value is exceeded. In this case, the apparent density of at least one heat-sensitive material increases by 2.5-10 times relative to the original state after heating above the corresponding threshold temperature value.

The above features of the microstructure of a heat-sensitive material provide a large number of phase boundaries in the original state relative to analogues mentioned in the prior art, and the greatest contrast of the color transition when the corresponding threshold temperature value indicated on the device is reached, thereby enhancing the technical result of the invention.

In some variants, the solid organic substance is an organic substance that, upon reaching a threshold temperature wit a difference of no more than 5° C. of that indicated on the device, undergoes a phase transition accompanied by an irreversible increase in the transparency of the heat-sensitive material. Moreover, in order to achieve the required packing of particles of solid organic substance in the invention, it is preferable to use organic compounds that include one or more aliphatic hydrocarbon chains. This is due to the fact that such organic substances have a crystalline packing in which elongated structural fragments of linear hydrocarbons are oriented parallel to each other, which ensures the formation of mainly flat particles, such as flakes or fibers (A. I. Kitaigorodsky, Molecular Crystals, M.: Science, 1971). Such crystalline packing causes anisotropy of solid organic substance and, as a consequence, the microstructure of the heat-sensitive material, as a result of which the properties of the material in the direction parallel to the surface of the base and the protective coating differ from the properties of the material in the direction perpendicular to the surface of the base and the protective coating. The anisotropy of the properties of the microstructure of a heat-sensitive material affects the strength of the material under bending and mechanical stress: application of impact in directions close to perpendicular to the surface of the base will not lead to damage to the material (A. I. Kitaigorodsky, Organic Crystal Chemistry, M., USSR Academy of Sciences, 1955).

In particular variants, the solid organic substance of the heat-sensitive material(s) is selected from the group: fatty aliphatic acids containing at least 13 carbon atoms; salts of fatty aliphatic acids containing at least 12 carbon atoms; alkanes containing at least 20 carbon atoms; dialkylphosphinic acids containing at least 16 carbon atoms; amides of fatty aliphatic acids containing at least 3 carbon atoms; anhydrides of fatty aliphatic acids containing at least 22 carbon atoms; fatty aliphatic alcohols containing at least 16 carbon atoms; fatty aliphatic amines containing at least 17 carbon atoms; nitriles of fatty aliphatic acids containing at least 20 carbon atoms or mixtures thereof. The melting temperature of a particular solid organic substance sets the threshold temperature of the corresponding heat-sensitive material of the device. Therefore, organic substances are selected in such a way that their melting temperatures are equal to the threshold temperatures of the device with a given accuracy. In this case, the number of carbon atoms for each class of organic substances is determined based on the specific practical task solved using the declared device (type of equipment, required step of the determined overheating temperature, area of the surface tested for heating, etc.).

Another factor determining the choice of a solid organic substance for a heat-sensitive material is the commercial availability of the substances, so the use of organic substances that are not readily available on an industrial or semi-industrial scale may not be commercially viable, despite the fact that such substances may satisfy other requirements. Preferably, the fatty aliphatic acids used as solid organic substances contain no more than 22 carbon atoms; salts of fatty aliphatic acids contain no more than 66 carbon atoms; alkanes contain no more than 40 carbon atoms; dialkylphosphinic acids contain no more than 20 carbon atoms; amides of fatty aliphatic acids contain no more than 22 carbon atoms; anhydrides of fatty aliphatic acids contain no more than 26 carbon atoms; fatty aliphatic alcohols contain no more than 32 carbon atoms; fatty aliphatic amines contain no more than 22 carbon atoms; nitriles of fatty aliphatic acids contain no more than 22 carbon atoms.

In particular cases, the solid organic substance of the heat-sensitive material(s) is selected from the group: palmitic acid, stearic acid, behenic acid, tetracosane, erucamide, stearic alcohol, cetyl alcohol, dispersed polyethylene, salts of saturated fatty carboxylic acids of rare earth metals, in particular lanthanum, yttrium, ytterbium, scandium.

In particular cases, the microstructure of at least one heat-sensitive material additionally contains a polymer binder that is transparent to at least part of visible light, the phase transition temperature of which is higher than the phase transition temperature of the solid organic substance. In this case, the heat-sensitive material contains the “solid-solid-gas” phase boundaries; during melting, an irreversible change in the microstructure of the material also occurs, as a result of which the number of voids decreases relative to the original state due to the release of the gas contained in them to the surface of the material and separation of gas and non-gas media occurs, as a result of which a decrease in the contact area of the solid phase and voids is observed, i.e. reducing the area of phase boundaries. In the process of reaching the surface, the gas filling the voids ensures a higher speed of diffusion processes in solids and viscous liquids than in solid-solid systems, which not only accelerates the change in the transparency of the heat-sensitive material, but also ensures the irreversibility of this change upon cooling. Additionally, an irreversible change in the microstructure of a heat-sensitive material can be accompanied by the formation of new thermodynamic phases, for example, a solid solution. Preferably, the polymeric binder is present in the heat-sensitive material in an amount of 1-30 wt. %. In particular cases, the polymer binder covers each individual structural particle of the solid organic substance, providing it with “glazing”. The binder is selected to ensure wettability, but not dissolution, of the particles of solid organic substance in the polymeric binder. Due to this, when “glazing” grains, crystals, fibers, flakes or conglomerates of these particles, additional gas capture occurs, in the environment of which a heat-sensitive material is formed, and its distribution between the “glazed” particles of solid organic substance by the binder. The given feature ensures the presence of a material microstructure with an increased number of phase boundaries, thereby enhancing the technical result of the invention.

In particular cases, the transparent polymer binder is selected from phenol formaldehyde resin, butyl methacrylic resin, melamine formaldehyde resin, polyvinyl butyral, polybutyl methacrylate, polyisobutyl methacrylate, polybutyl acrylate, phenoxy resin, polystyrene acrylic emulsion, polyolefin, polystyrene, polyacrylate, polyethersulfone, polyethylene, polypropylene, polystyrene, polyvinylidene fluoride, polytetrafluoroethylene, polyethersulfone, polyisoprene, polypropylene, polybutadiene, polyisobutylene, polyvinyl acetate, polymethacrylate, ethylcellulose, polyvinyl chloride, polyvinylidene chloride, polycarbonate, polycaprolactone, polyethylene terephthalate resin, polybutylene terephthalate resin, polyamide resin, polyvinylidene fluoride, polyester, polyester resins, hydroxyethylcellulose, methylcellulose, ethylcellulose, nitrocellulose, carboxymethylcellulose, gelatin, agar-agar, casein, gum arabic, polyvinyl alcohol, polyethylene oxide or mixtures thereof.

The devices may be various types of products designed to be securely fastened and tightly fitted to the surface of the controlled equipment, including industrial, household and energy purposes.

In preferred variants of the group of inventions, the device may be a sticker including an insulating layer, an adhesive layer, an elastic base that is non-transparent to at least part of visible light, made of halogen-containing polymers, having a thickness of less than 1 mm and a dielectric strength of at least 5 kV/mm, at least one heat-sensitive material applied to individual sections of the base, with a thickness of not more than 800 microns, a transparent protective layer, in which the heat-sensitive material is designed with the possibility of an irreversible change in transparency upon reaching the corresponding threshold temperature indicated on the device, in a time of less than 5 seconds.

The use of a halogen-containing polymer base, for example, polyvinyl chloride, makes it possible to use the claimed device for visually recording the excess of temperature of the surfaces of conductive elements of electrical installations, since the specified base has dielectric properties and fire resistance. The design of the device with an elastic base less than 1 mm thick makes it possible for the device to tightly adhere to surfaces of complex geometry, including conductive elements of electrical equipment. Also, the use of a base with a thickness of less than 1 mm and a layer of heat-sensitive material with a thickness of no more than 800 microns allows you to quickly warm up the heat-sensitive material when short-term overheating occurs and completely transform it into a melt with the “non-transparent-transparent” color transition within no more than 5 seconds, and also provides the necessary heat transfer during air cooling of operating devices. The operating speed of the heat-sensitive material of less than 5 seconds when heated above the corresponding threshold temperature makes it possible to record short-term emergency overheating caused by starting currents or the passage of short-circuit currents, excessive starting load of motors, cold running, switching or other processes. In addition, the small thickness of the device allows you to accurately identify areas of local overheating of surfaces when using stickers with a large area of the heat-sensitive layer due to the low heat dissipation in the base and heat-sensitive material along the plane of the controlled surface.

In other variants of the group of inventions, the device can be made in the form of an elastic hollow tube (cambric) or in the form of a tube including a longitudinal cut (clip), and intended for fastening to wires, the surface of which acts as a base that is non-transparent to at least part of visible light, made of halogen-containing polymers, having a thickness of less than 1 mm and a dielectric strength of at least 5 kV/mm, on individual sections of the front surface of which at least one heat-sensitive material with a thickness of not more than 800 microns is applied, covered with a transparent protective layer, in which the heat-sensitive material is designed with the possibility of an irreversible change in transparency upon reaching the corresponding threshold temperature indicated on the device, in a time of less than 5 seconds.

Unlike a sticker, a clip or cambric are more convenient for installation on small-section wires in electrical panels of buildings and structures.

To increase the visibility of both the device itself and the fact of its operation, and, as a result, to further increase the safety of equipment operation, the base may have reflective or luminescent properties.

In other variants of the device, increased accuracy in determining local overheating of electrical equipment surfaces can be achieved by the fact that the surface area of the base covered with at least one heat-sensitive material is at least 100 mm².

In variants, when local heating of the controlled surface is carried out, the transparency of only that area of the heat-sensitive material that was subject to heating above the threshold temperature changes, which makes it possible to record point overheating.

The technical result is also achieved due to variants of the method for manufacturing the device for visually recording the excess of temperature above at least one threshold value, the disclosed variants are not limiting, and other methods can be used to manufacture the said device, ensuring the production of a heat-sensitive material with a microstructure disclosed in the materials.

In the first variant, the method for manufacturing the device for visually recording the excess of temperature above at least one threshold value includes the following steps:
applying to individual sections of the non-transparent base one or more layers of at least one suspension of particles of solid organic substance in the liquid phase, the boiling temperature of which is less than 180° C., wherein the solubility of particles of solid organic substance in the liquid phase does not exceed 10 g/kg;
removing the liquid phase from the applied layers of suspension of particles of solid organic substance in the liquid phase to form a heat-sensitive material that is non-transparent to at least part of visible light, the microstructure of which includes particles of solid organic substance and voids filled with the gas phase;
covering the front surface of the workpiece with a transparent protective layer, wherein at least one of the above steps is carried out at sub-atmospheric pressure.

In this variant, due to the use of reduced pressure (sub-atmospheric pressure) in at least one of the stages, rapid removal of the liquid phase is ensured, similar to boiling, as a result of which additional foaming of the material is observed, leading to an increase in the number of voids. Moreover, when using sub-atmospheric pressure at one of the stages, the removal of the liquid phase from the applied layers of suspension of particles of solid organic substance in the liquid phase occurs at atmospheric pressure at other stages.

In preferred implementation variants of the method for manufacturing the device, the sub-atmospheric pressure is used at the stage before applying the transparent protective layer or at the stage of layer-by-layer application of at least one suspension of at least one particle of solid organic substance in the liquid phase after removing the liquid phase from each individual layer. When using the implementation of the method for manufacturing the device, the sub-atmospheric pressure is preferably 1-650 mmHg. The selected pressure value, as well as the holding time of the device workpiece at a given pressure, depends on the boiling temperature of the liquid phase, its quantity used to prepare the suspension, as well as the nature of the solid organic substance.

The sub-atmospheric pressure can be created immediately after applying each individual layer of suspension of solid organic substance in the liquid phase. In this case, the microstructure including particles of solid organic substance and voids filled with the gas phase is formed layer by layer. In another variant of this method, the sub-atmospheric pressure can be created at the stage of removing the liquid phase from the required number of applied layers of suspension of solid organic substance in the liquid phase. In this case, there will be a spontaneous release of the liquid phase from the entire volume of the material with the formation of a larger number of unstructured voids. In the third variant of this method, the front surface of the workpiece is covered with a transparent protective layer at a sub-atmospheric pressure. When using a hermetically sealed protective layer, this ensures the sub-atmospheric pressure inside the voids of the heat-sensitive material in the final product. In addition, creating the sub-atmospheric pressure at this stage makes it possible to remove the residual liquid phase occluded by the heat-sensitive material, and since in the process of creating the sub-atmospheric pressure, the residual liquid phase evaporates abruptly, this results in additional foaming of the material, leading to an increase in the number of voids.

The sub-atmospheric pressure can be created at any two stages of device manufacture, as well as at all three stages of device manufacture, depending on the nature of the solid organic substance, the liquid phase used and the concentration of the solid organic substance in the suspension, ensuring the formation of the required microstructure of the heat-sensitive material.

Moreover, when manufacturing a device by this method, particles of solid organic substance can be made in the form of flakes, fibers, grains, crystals or conglomerates of the said particles.

In the second variant, the method for manufacturing the device for visually recording the excess of temperature above at least one threshold value includes performing at least 3 cycles, each of which includes applying a layer of at least one suspension of particles of solid organic substance in the liquid phase to individual sections of the non-transparent base and removing the liquid phase from the applied layers of suspension, with further coating of the front surface of the workpiece with a transparent protective layer, while the boiling temperature of the liquid phase is less than 180° C., while the suspension of particles of solid organic substance in the liquid phase is applied by a method selected from the group: screen printing, flexographic printing, tampon printing, silk-screen printing, producing a microstructure of at least one heat-sensitive material in which particles of solid organic substance are oriented predominantly parallel to the plane of the surface of the base.

In this variant, after applying the first layer of at least one suspension of particles of solid organic substance in the liquid phase, the workpiece is dried at room temperature to a constant weight, then the procedure of layer-by-layer application and removal of the liquid phase from the applied layers of suspension is repeated at least three times until the required coating thickness is obtained. In a particular case, the method of screen printing, flexographic printing, tampon printing or silk-screen printing is used when applying at least one suspension of particles of solid organic substance in the liquid phase in layers to individual sections of the non-transparent base. The alternation of cycles of applying and removing the liquid phase from the applied layers of suspension ensures the necessary ordering of the particles of solid organic substance when they are located on the base. Due to the spontaneous removal of the liquid phase from the applied layers of suspension at room temperature, slow settling of the flakes and their packing in a thermodynamically favorable state is ensured. Thus, a layer of heat-sensitive material is formed with a microstructure in which the particles of solid substance are located predominantly parallel to the surface of the base. To ensure the required hiding power, the cycles of applying and removing the liquid phase from the applied layers of suspension are repeated at least three times until a heat-sensitive material is non-transparent to at least part of visible light.

In this case, when manufacturing a device by this method, particles of solid organic substance are predominantly made in the form of flakes, fibers, crystals or conglomerates of these or other particles with linear dimensions exceeding the thickness.

In variants of the methods for manufacturing a device according to the claimed group of inventions, the thickness of the heat-sensitive material is preferably no more than 800 microns, preferably no more than 450 microns, most preferably no more than 150 microns.

Preferably, when implementing the methods for manufacturing a device, a suspension including particles of solid organic substance in size of 2-3 microns in the liquid phase is used. The difference in density between the liquid phase and the solid organic substance is preferably less than 0.2 g/cm³. For this purpose, the liquid phase can be selected from the group: isopropanol, water, methanol, 1-propanol, isobutanol, ethylene glycol monomethyl ether, 1-butanol, acetonitrile, acetic acid, hexane, heptane, 1,1,1-trifluoroethanol, 1, 1,1,3,3,3-hexafluoroisopropanol, dimethylformamide, ethanol, butyl acetate, acetone, toluene or mixtures thereof, but are not limited to.

The relative difference in density between the solvent and the particles of solid fusible substance is an important factor influencing the rate and nature of settling of particles of solid organic substance. If there is a large difference in density (more than 0.2 g/cm³), the particles of solid organic substance will settle from the suspension too quickly, as a result of which the particles will form both longitudinal and transverse structures, oriented randomly relative to the plane of the base. In this case, the base will be visible through the transverse structures at the same layer thickness for which the hiding power will be achieved with a longitudinal arrangement, therefore only the longitudinal arrangement of particles provides the required hiding power. At comparable densities or with a difference in densities of less than 0.2 g/cm³, slow settling of particles of solid organic substance will be observed with the formation of the necessary ordered microstructure of the material with a predominantly longitudinal arrangement of particles relative to the surface of the base.

To ensure safety when using a device according to the claimed group of inventions in the energy sector, for example, for visually recording the excess of temperature of the surfaces of conductive elements of electrical installations, a halogen-containing polymer base, for example, polyvinyl chloride, is used as a basis in variants of the method for manufacturing the device, since it is fire-resistant and has dielectric properties.

Substances selected from the classes of substances given on page 33 of this description can be used as solid organic substances in the claimed variants of the method for manufacturing the device.

### BRIEF DESCRIPTION OF DRAWINGS

The invention will be better understood from a non-limiting description given with reference to the accompanying drawings, which show:

FIG. 1—Various performance variants of the device for visually recording the excess of temperature above at least one threshold temperature value: 1a—in the form of a tube including a longitudinal cut (clips), intended for fastening to wires, with one heat-sensitive material, 1b—in the form of an elastic hollow tube (cambric), intended for putting on wires, with three different heat-sensitive materials, 1c—in the form of a sticker with four different heat-sensitive materials.

FIG. 2—Layered structure of the device for visually recording excess of temperature 2a—above one threshold temperature with a hermetically sealed transparent protective layer, 2b—above one to three different threshold temperatures with a transparent protective layer, in which a gap is made between the protective layer and the base, 2c—above one to four different threshold temperatures with a transparent protective layer, in which micro-holes are made.

FIG. 3—Device for visually recording the excess of temperature above at least one threshold temperature value: 3a—initial appearance of the device in the form of a sticker with one heat-sensitive material, 3b—operated type of the device in the form of a sticker with one heat-sensitive material (after exceeding the threshold temperature value), 3c—initial appearance of the device in the form of a sticker with three different heat-sensitive materials, 3d, e—partially operated sticker after the threshold temperature value of the first (3d) and second (3e) heat-sensitive materials has been exceeded, 3f—fully operated sticker after the threshold temperature value of the third heat-sensitive material has been exceeded, 3g—initial appearance of the device in the form of a sticker with a base having reflective or luminescent properties, with four different heat-sensitive materials, 3h—fully operated sticker with a base having reflective or luminescent properties, after exceeding the threshold temperature value of the fourth heat-sensitive material with a visual color transition “white-black”, 3i—layered structure of the device for visually recording excess of temperature with four different heat-sensitive materials, using a base with reflective or luminescent properties, coated with black paint in the areas of heat-sensitive materials, with a transparent protective layer in which micro-holes are made.

FIG. 4—Microstructure of a heat-sensitive material with particles in the form of flakes and their conglomerates without a binder before operation (4a) and after operation (4b); flakes and their conglomerates with a binder, before operation (4c) and after operation (4d); fibers and their conglomerates without a binder, before operation (4e) and after operation (4f).

FIG. 5—Device for visually recording excess of threshold temperature value during local overheating: 5a—initial appearance of the device, 5b—partially operated device after point heating of the controlled surface above the threshold temperature value with a change in transparency of only that area of the heat-sensitive material that was subject to heating above the threshold temperature, while maintaining a non-transparent area of the given material in its remaining zone that was not subject to heating.

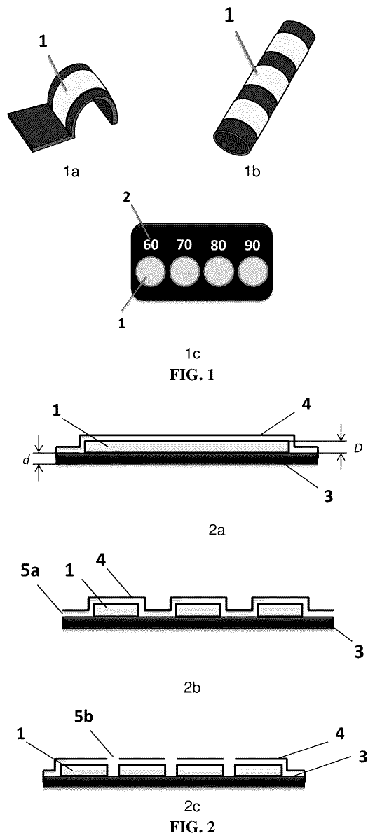

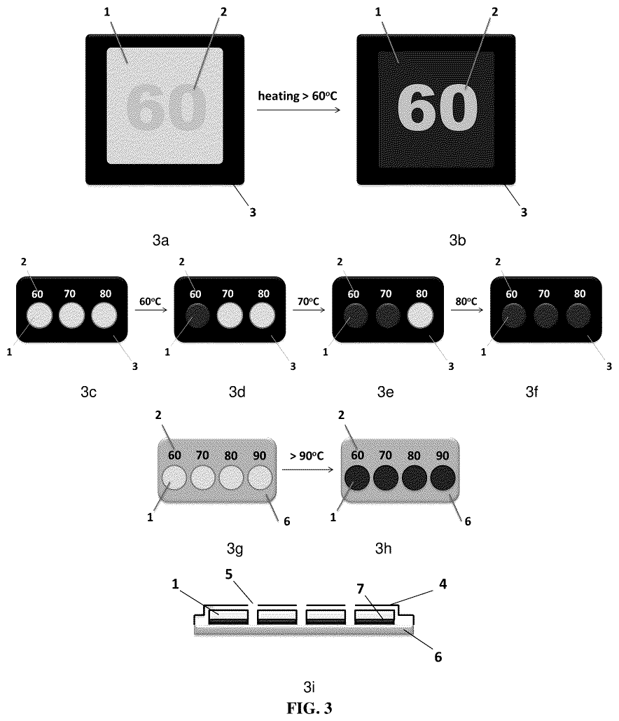

FIG. 1 shows various variants of the device for visually recording the excess of temperature above at least one threshold temperature value, which are a tube including a longitudinal cut (clip) (1a), intended for fastening to wires, with one heat-sensitive material 1, an elastic hollow tube (cambric) (1b), intended for fastening to wires, with three different heat-sensitive materials 1 or a sticker (1c) with four different heat-sensitive materials 1 and inscriptions 2, including numerical values of the recorded temperatures.

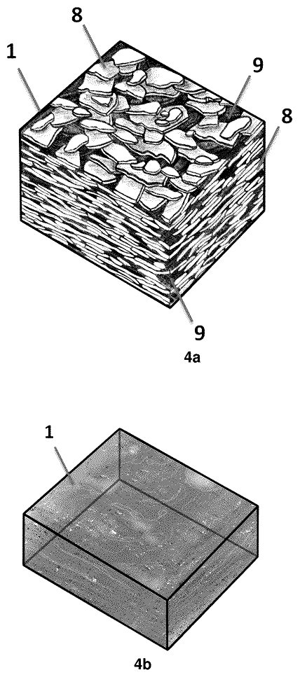

FIG. 2 shows the layered structure of the device for visually recording the excess of temperature above one threshold temperature value: (2a), including a flexible base 3 of thickness d and a heat-sensitive material 1 applied to it with thickness D and a transparent protective layer 4, tightly adhering to the base and material, providing the hermetic seal of the device and the ability to maintain sub-atmospheric pressure; layered structure of the device for visually recording the excess of temperature above one to three different threshold temperature values (2b), including a flexible base 3 and heat-sensitive materials 1 applied to it with a transparent protective layer 4, tightly adhering to the base and material and having a gap 5a between the protective layer and base; layered structure of the device for visually recording the excess of temperature above one to four different threshold temperature values (2c), including a flexible base 3 and heat-sensitive materials 1 applied to it with a transparent protective layer 4, tightly adhering to the base and material and having micro-holes 5b on its front surface.

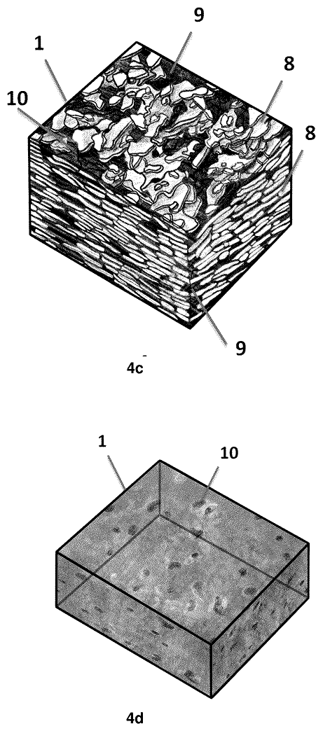

FIG. 3 shows the device for visually recording the excess of temperature above one threshold temperature value in the form of a sticker in the original state before heating (3a) and after heating above the threshold temperature value (3b), including a flexible base 3, a heat-sensitive material 1 applied to it and an inscription 2, including the numerical value of the recorded temperature threshold; device for visually recording the excess of temperature above one to three different threshold temperature values in the original state before heating (3c), after heating above the first threshold temperature value (3d), after heating above the second threshold temperature value (3e) and after heating above the third threshold temperature value (3f), including a flexible base 3, heat-sensitive materials 1 applied to it and inscriptions 2, including numerical values of the recorded threshold temperature values for each heat-sensitive material; device for visually recording the excess of temperature above one to four different threshold temperature values in the original state before heating (3g), after heating above the fourth threshold temperature value (3h) and layered structure of this device (3i), including a flexible base with reflective or luminescent properties 6, heat-sensitive materials 1 applied to it and inscriptions 2, including numerical values of the recorded threshold temperature values for each heat-sensitive material, black paint 7 applied to a flexible base in zones under heat-sensitive materials, as well as a transparent protective layer 4, tightly adhering to the base and material and having micro-holes 5b on its front surface.

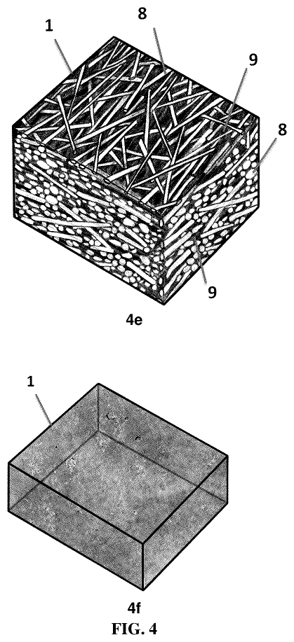

FIG. 4 shows the microstructure of a heat-sensitive material 1 without binder with particles 8 made in the form of flakes and their conglomerates, and voids 9 before heating (4a) and the microstructure of a heat-sensitive material 1 with reduced fraction of voids and with increased apparent density and with particles fused and losing their original shape after heating above the threshold temperature value (4b); microstructure of a heat-sensitive material 1 with binder 10 with particles 8 made in the form of cells and their conglomerates, and voids 9 before heating (4c) and microstructure of heat-sensitive material 1 with binder 10 with reduced fraction of voids and with increased apparent density and with particles fused and losing their original shape after heating above the threshold temperature value (4d); microstructure of heat-sensitive material 1 without binder with particles 8 made in the form of fibers and their conglomerates, and voids 9 before heating (4e) and microstructure of a heat-sensitive material 1 with reduced fraction of voids and with increased apparent density and with particles fused and losing their original shape after heating above the threshold temperature values (4f).

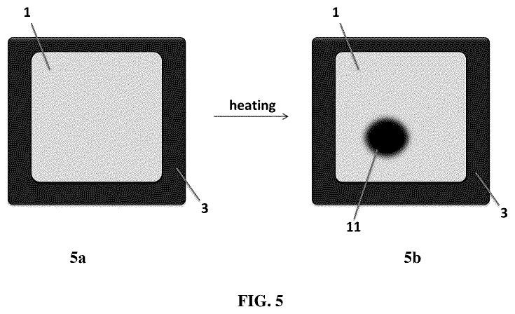

FIG. 5 shows the device for visually recording the excess of threshold temperature value during local overheating, including a flexible base 3 and a heat-sensitive material 1 applied to it before heating (5a) and after point heating (5b) of the controlled surface, as a result of which the transparency of only that area 11 of the heat-sensitive material 1 that was subject to heating above the threshold temperature changes, while maintaining the original state of the rest of the area of the heat-sensitive material 1.

### IMPLEMENTATION OF THE INVENTION

### Preparation of Heat-Sensitive Material.

The solid organic substance of at least one heat-sensitive material may be selected from at least one of the following classes of organic substances: fatty aliphatic acids containing at least 13 carbon atoms; salts of fatty aliphatic acids containing at least 12 carbon atoms; alkanes containing at least 20 carbon atoms; dialkylphosphinic acids containing at least 16 carbon atoms; amides of fatty aliphatic acids containing at least 3 carbon atoms; anhydrides of fatty aliphatic acids containing at least 22 carbon atoms; fatty aliphatic alcohols containing at least 16 carbon atoms; fatty aliphatic amines containing at least 17 carbon atoms; nitriles of fatty aliphatic acids containing at least 20 carbon atoms or mixtures thereof.

Preferably, the fatty aliphatic acids used as solid organic substances contain no more than 22 carbon atoms; salts of fatty aliphatic acids contain no more than 66 carbon atoms; alkanes contain no more than 40 carbon atoms; dialkylphosphinic acids contain no more than 20 carbon atoms; amides of fatty aliphatic acids contain no more than 22 carbon atoms; anhydrides of fatty aliphatic acids contain no more than 26 carbon atoms; fatty aliphatic alcohols contain no more than 32 carbon atoms; fatty aliphatic amines contain no more than 22 carbon atoms; nitriles of fatty aliphatic acids contain no more than 22 carbon atoms.

In particular variants of the invention, the solid organic substance of at least one heat-sensitive material is selected from at least one of the following substances: yttrium capronate, yttrium behenate, yttrium undecanate, yttrium laurate, yttrium tridecan laurate, yttrium tridecane pentadecanoate, yttrium tridecanate, yttrium pentadecanate, yttrium palmitate, ytterbium caprylate, lanthanum palmitate, lanthanum nonadecynate, lanthanum capronate, erbium undecanoate, zinc nonadecanoate, zinc palmitate, zinc capronate, zinc myristinate, zinc stearate, cadmium laurate, cadmium laurine myristinate, lead caprate, lead stearate, lead laurate, la Lead urine myristinate, stearate copper, calcium stearate, lithium stearate, stearic acid, lauric acid, docosanoic acid, eicosanoic acid, crotonic acid, arachidic acid, myristic acid, palmitic acid, adipic acid, octanoic acid, capric acid, tricosanoic acid, tetratriacontanoic acid, 2,3-dimethylnonanoic acid, brassidic acid, 2-methyl-2-dodecenoic acid, eleostearic acid, behenoleic acid, behenic acid, oleamide, stearamide, lauramide, erucylamide, capric acid amide, myristic acid amide, caprylic acid amide, palmitic acid anilide, salicylic acid anilide, beta-naphthylamide caproic acid, enanthic acid phenylhydrazide, hexylamide, octacosylamide, N-methylheptacosylamide, salicylamide, hexadecanol, ecucamide, 1-docozonol, trilaurin, tricosylamine, dioctadecylamine, NN-dimethyloctylamine, dioctylphosphinic acid, tritriacontane, tetracosane, stearic alcohol, cetyl alcohol, dispersed polyethylene, chloride stearic anhydride, palmitic anhydride, stearic and acetic anhydride, lauric anhydride or mixtures thereof.

In various variants, the solid fusible substance of each of the heat-sensitive materials may have a melting temperature in the range of 50-210° C. In this case, the numerical threshold temperature values of at least one heat-sensitive material are selected from the group of 50° C., 55° C., 60° C., 70° C., 80° C., 90° C., 100° C., 110° C., 120° C., 130° C., 140° C., 150° C.

To produce a heat-sensitive material, a solid organic substance is ground in a ball mill to a size of 2-3 microns, a liquid phase represented by water or an organic solvent with a boiling temperature of less than 180° C. is sequentially added, and the resulting suspension is stirred, while mainly during this period, it is ensured periodic dispersion of the mixture with access of air until a constant density of the mixture is obtained. The liquid phase is preferably water or an organic solvent in which the solubility of the organic solid substance does not exceed 10 g/kg.

In preferred variants of the invention, the liquid phase is added in an amount of 50 vol. % to 90 vol. %.

The difference in density between the liquid phase and the solid organic substance is preferably less than 0.2 g/cm³. For this purpose, the liquid phase can be selected from the group: isopropanol, water, methanol, 1-propanol, isobutanol, ethylene glycol monomethyl ether, 1-butanol, acetonitrile, acetic acid, hexane, heptane, 1,1,1-trifluoroethanol, 1,1,1,3,3,3-hexafluoroisopropanol, dimethylformamide, ethanol, butyl acetate, water, acetone, toluene or mixtures thereof, but are not limited to.

With this method of production, the resulting heat-sensitive material is represented by two continuous phases: solid and gas.

In this case, the resulting heat-sensitive material in the original state is non-transparent to at least part of visible light, and when heated above the corresponding threshold temperature value, an irreversible change in the microstructure of the corresponding heat-sensitive material occurs, accompanied by the fusion of particles of solid organic substance, a decrease in the fraction of voids and an increase in its transparency with the development of the color of the base, and when subsequently cooled, the transparency of the heat-sensitive material does not return to its original values.

Depending on the nature of the solid organic substance, the type of the resulting particles of solid organic substance may be grains, crystals, fibers, flakes, or conglomerates of these particles.

In some variants of the invention, the ground solid organic substance is suspended in a solution of a binder in a liquid phase that is transparent to at least part of visible light. In preferred variants of the invention, the binder is present in the resulting heat-sensitive material in an amount of 1-30 wt. %, to provide the effect of glazing the particles of solid organic substance.

In this case, the transparent polymer binder is selected from: phenol formaldehyde resin, butyl methacrylic resin, melamine formaldehyde resin, polyvinyl butyral, polybutyl methacrylate, polyisobutyl methacrylate, polybutyl acrylate, phenoxy resin, polystyrene acrylic emulsion, polyolefin, polystyrene, polyacrylate, polyethersulfone, polyethylene, polypropylene, polystyrene, fluoride, polytetrafluoroethylene, polyvinylidene polyethersulfone, polyisoprene, polypropylene, polybutadiene, polyisobutylene, polyvinyl acetate, polymethacrylate, ethylcellulose, polyvinyl chloride, polyvinylidene chloride, polycarbonate, polycaprolactone, polyethylene terephthalate resin, polybutylene terephthalate resin, polyamide resin, polyvinylidene fluoride, polyester, polyester resins, hydroxyethylcellulose, methylcellulose, ethylcellulose, nitrocellulose, carboxymethylcellulose, gelatin, agar-agar, casein, gum arabic, polyvinyl alcohol, polyethylene oxide or mixtures thereof, but are not limited to them.

In this case, the heat-sensitive material contains the “solid-solid-gas” phase boundaries; during melting, an irreversible change in the microstructure of the material also occurs, as a result of which the number of voids decreases relative to the original state due to the release of the gas contained in them to the surface of the material and separation of gas and non-gas media occurs.

The resulting suspension without or with a binder is used for application immediately after it is obtained.

### Selecting the Base of the Device

The claimed device may be in the form of a sticker, clip or cambric, or other devices made with the ability to securely fasten and tightly adhere to the surface of the controlled equipment.

The devices have a layered structure including: a base, a base that is non-transparent to at least part of visible light, at least one heat-sensitive material applied to the surface of the base, and a transparent protective layer that partially or completely isolates the heat-sensitive material from the environment.

In the case of a clip and a cambric, the outer surface of a tube including a longitudinal cut or the outer surface of an elastic hollow cylinder, respectively, acts as a base that is non-transparent to at least part of visible light.

The thickness of the base of the device is preferably less than 1 mm to ensure the operating speed of each of the temperature-sensitive materials is less than 5 seconds when heated above the corresponding threshold temperature.

The basis for various types of devices can be selected from the following materials: OraJet 3106SG, 3951 PVC films, 3981RA polyurethane film, 3M polyester film: 7874 E or WHITEV TC 50/RC20/HD70WH self-adhesive paper film, ORALITE 5500 methyl methacrylate film, but not limited to them. When using a halogen-containing polymer base, in particular PVC, the dielectric strength of the device is preferably at least 5 kV/mm, which is preferable when using the device in the energy sector.

In some variants, a pattern may be applied to the surface of the base, intended for marking phases or components of electrical equipment, containing graphic, numerical or text information, and the base itself may have reflective or luminescent properties for increasing the visibility of both the device itself and the fact of its operation, which serves to further increase the safety of equipment operation.

To increase the contrast of the color transition, the base in the zone of at least one heat-sensitive material is painted, for example, black. In this case, the temperature-sensitive material is preferably white, thereby providing a visual “white-black” transition when at least one temperature-sensitive material is operated.

### Manufacturing the Device for Visually Recoding the Excess of Temperature Above at Least One Threshold Value.

In general, the process of manufacturing a device includes the stages of applying one or more layers of at least one suspension of particles of solid organic substance in the liquid phase to individual sections of a non-transparent base, removing the liquid phase from the applied layers of the suspension of applied layers, and also covering the front surface of the workpiece with a transparent protective layer.

To obtain a microstructure of the applied heat-sensitive material, providing an irreversible change in appearance when a threshold temperature is reached, which is accompanied by the melting of particles of solid organic substance, a decrease in the fraction of voids and an increase in its transparency with the development of the color of the base, you can use, in particular, the following techniques in the previously disclosed stages of the method:
at least one of the above stages of the method (applying suspension of particles of solid organic substance in the liquid phase, removing the liquid phase from the applied layers of the suspension, covering the front surface of the workpiece with a transparent protective layer) is carried out at sub-atmospheric pressure.
at least 3 cycles of applying layers of at least one suspension of particles of solid organic substance in the liquid phase and removing the liquid phase from the applied layers of this suspension are carried out, while suspension of particles of solid organic substance in the liquid phase is applied by a method selected from the group: screen printing, flexographic printing, tampon printing, silk-screen printing, with obtaining a microstructure of at least one heat-sensitive material, particles of solid organic substance in which are oriented predominantly parallel to the plane of the surface of the base.

The liquid phase can be removed from the applied layers of suspension of particles of solid organic substance in the liquid phase or from each layer separately, both at sub-atmospheric pressure and at atmospheric pressure, depending on the selected method for manufacturing the device.

The sub-atmospheric pressure, in particular cases of obtaining a device, can be used both immediately after applying each individual layer of suspension of solid organic substance in the liquid phase, and at the stage of drying (i.e. removing the liquid phase) of the required number of applied layers of suspension of solid organic substance in the liquid phase. In this case, spontaneous release of the liquid phase occurs from the volume of the material (sequentially from each layer or from the entire volume of the material) with the formation of a larger number of unstructured voids. In other words, when using sub-atmospheric pressure, a rapid removal of the liquid phase occurs, similar to boiling, which results in additional foaming of the material, leading to an increase in the number of voids. In addition, sub-atmospheric pressure can be used at the stage of coating with a hermetically sealed protective layer. This will not only prevent the formation of a bubble on the surface of the protective layer when the device is operated, but will also ensure the removal of the residual liquid phase occluded by the heat-sensitive material with additional foaming of the material and an increase in the number of voids. In this case, after applying the last layer, the device is dried by selecting the mode for removing the liquid phase from the applied layers of suspension, preferably at a temperature of (20±2)° C. for at least 1 hour, and only after that the sub-atmospheric pressure is used and covered with a protective layer.

The sub-atmospheric pressure can be applied at any two stages of device manufacturing, as well as at all three stages of device manufacturing, which also results in obtaining a heat-sensitive material with the required microstructure.

The layer-by-layer application of suspension of solid organic substance in the liquid phase can also provide the claimed device. In this case, after applying at least one heat-sensitive material, the device is dried by selecting the mode for removing the liquid phase from the applied layers of suspension, preferably at a temperature of (20±2)° C. for 10 minutes in an air atmosphere, then the layer-by-layer application procedure is repeated until the required coating thickness is obtained. The microstructure, which includes particles of solid organic substance and voids filled with the gas phase, is formed layer by layer. Layer-by-layer application with exposure, preferably at room temperature, between approaches ensures the necessary ordering of the particles of the solid fusible substance when they are located on the device. If the particles of the solid fusible substance are flakes, in order to achieve hiding power with a minimum layer thickness, it is preferable to arrange them longitudinally “overlapping” on the flexible base of the device. In this case, the flakes will be arranged like closed blinds and a thin layer of flakes will be enough to cover the base color (“closed blind principle”). Due to the spontaneous removal of the liquid phase from the applied layers of suspension at room temperature, slow settling of the flakes and their packing in a thermodynamically favorable state is ensured. When using this technique in the preparation of a heat-sensitive material, the predominant formation of a continuous solid phase of solid organic substance is observed, and the voids filled with gas form a continuous gas phase. When carrying out forced removal of the liquid phase from the applied layers of suspension by heating or air blowing, the kinetic processes of solvent evaporation will prevail over the thermodynamic ordering of particles of solid organic substance, as a result of which the flakes will form not longitudinal, but transverse structures (“open blind principle”), through which the base will be visible at the same layer thickness, for which hiding power will be achieved when observing the closed blind principle.

Such ordering can also be achieved by using a dilute suspension of particles of solid fusible substance in the liquid phase (dilution of more than 50%), since a larger volume will allow the flakes to orientate properly and settle in an ordered form, in contrast to the use of more concentrated suspensions. In addition, high dilution guarantees a longer process of spontaneous evaporation of the liquid phase, during which the flakes will also be laid according to the closed blind principle. Another factor influencing the speed and nature of settling of particles of solid organic substance is the relative difference in density between the solvent and particles of solid fusible substance. If there is a large difference in density (more than 0.2 g/cm³), particles of solid organic substance will settle from the suspension too quickly according to the open blind principle. At comparable densities or with a difference in densities of less than 0.2 g/cm³, slow settling of particles of solid organic substance will be observed with the formation of the necessary ordered microstructure of the material and in compliance with the closed blind principle.

Thus, compliance with the open blind principle when forming the microstructure of a heat-sensitive material makes it possible to obtain a material whose microstructure in the original state has a preferential orientation of particles of solid substance parallel to the surface of the base and protective coating.

The layers of suspension of solid organic substance in the liquid phase are preferably applied by a method selected from screen printing, flexographic printing, tampon printing, silk-screen printing.

Flexographic printing ensures capturing the suspension by an anilox roller and transferring it to the convex parts of the relief printing form, as a result of which the printing form is covered with a thin layer of suspension, which is transferred to the base. In this case, the formation of an ordered arrangement of particles predominantly parallel to the surface begins already at the stage of capturing the suspension by anilox; when transferred to the convex parts of the printing form, the layer of suspension becomes thinner, facilitating further ordering of the particles, and when the suspension is transferred to the base, the ordering process is completed, ensuring the arrangement of particles of solid organic substance according to the “closed blind” principle. When implementing tampon printing, a tampon or roller is used to transfer a suspension of solid organic substance in the liquid phase, on which particles of solid organic substance also begin to form according to the “closed blinds” principle. Application to the base completes the ordering process to obtain the required microstructure of the heat-sensitive material.

Silk-screen printing and screen printing are implemented using a screen printing form or matrix, which is a fine-meshed net made of monofilament polyester, polyamide or metal threads. In this case, a suspension of solid organic substance in the liquid phase is pressed onto the base through the net using a squeegee, due to which particles of solid organic substance are laid parallel to the surface of the base. Repeated rolling of the squeegee over the net allows predominantly all particles of solid organic substance to be oriented according to the “closed blind” principle.

The effects described above are applicable to variants of the device in which the microstructure of the heat-sensitive material is represented by a solid organic substance, the particles of which are predominantly in the form of flakes, crystals or fibers, i.e. such particles whose linear dimensions exceed their thickness. In this case, the formation of aggregates (conglomerates) of individual particles (flakes, crystals or fibers) of solid organic substance may be observed.

In the case of using a heat-sensitive material containing a solid organic substance, a binder and voids, a suspension of finely dispersed solid organic substance in a binder solution in the liquid phase is used to prepare the heat-sensitive material. When the liquid phase evaporates, the binder settles on particles of solid organic substance, covering their surface with a thin uniform layer. In this case, both an individual particle of solid organic substance and the resulting conglomerate of particles are “glazed”.

When applying a suspension of particles of solid organic substance in the liquid phase, the area of the front surface of the device base that should not come into contact with at least one heat-sensitive material is sealed with polyethylene film. A layer of at least one suspension of particles of solid organic substance in the liquid phase is uniformly applied to the uncovered area of the base using one of the techniques described above.

In preferred variants, the thickness of the layer of heat-sensitive material is no more than 800 microns, preferably no more than 450 microns, most preferably no more than 150 microns. The use of the specified thickness of the layer of at least one heat-sensitive material ensures that each of them operates at a speed of less than 5 seconds when heated above the threshold temperature corresponding to each material. This is due to the fact that this thickness of the material layer, in combination with the thickness of the base of the device, allows heating the heat-sensitive material when short-term overheating occurs during peak load periods and completely converting it into a melt with the “non-transparent-transparent” color transition in less than 5 seconds, and also provides the necessary heat transfer during air cooling of operating devices.

In preferred variants, the surface area of the non-transparent base coated with one or more heat-sensitive materials is at least 100 mm².

In some variants of the invention, the uncovered area of the base is first coated with black paint or an inscription using solvent dyes, including, in particular, the numerical threshold temperature value or other graphic, numerical or textual information, and then a layer of heat-sensitive material is applied. Moreover, in preferred variants of the invention, at least 70% of the base area is covered with black paint. In the case of painting at least part of the base in black color, at least one heat-sensitive material in the original state has a white color, and when heated above the corresponding threshold temperature, a visual “white-black” color transition of at least part of the surface of the device occurs.

The number of heat-sensitive materials is not limited by an upper limit, and depends on the practical task implemented using the declared device (type of equipment, required step of the determined overheating temperature, area of the surface tested for heating, etc.). In particular cases, three or four different heat-sensitive materials are applied to the front surface of the base. In this case, heat-sensitive materials can be applied to both adjacent and non-adjacent areas of the front surface of the base.

For example, for a device containing three different heat-sensitive materials, the threshold temperatures may be 50° C., 55° C., 60° C., that is, the first heat-sensitive material changes transparency when it reaches 50° C., the second heat-sensitive material changes transparency when it reaches 55° C., and the third heat-sensitive material changes transparency when it reaches 60° C., with an accuracy of 5° C. In other variants, the threshold temperatures may be 50° C., 60° C., 70° C., or 50° C., 70° C., 80° C., or 60° C., 70° C., 80° C., or 60° C., 80° C., 100° C., or 60° C., 90° C., 110° C., or 70° C., 80° C., 90° C., or 70° C., 90° C., 110° C., or 70° C., 100° C., 120° C., or 70° C., 110° C., 130° C., or 80° C., 90° C., 100° C., or 80° C., 120° C., 140° C., or 80° C., 120° C., 150° C., or 90° C., 100° C., 110° C., or 90° C., 110° C., 130° C., or 100° C., 120° C., 140° C.

For a device containing four different heat-sensitive materials, the threshold temperatures may be 50° C., 55° C., 60° C., 70° C., or 50° C., 60° C., 70° C., 80° C., or 50° C., 70° C., 90° C., 110° C., or 60° C., 70° C., 80° C., 90° C., or 60° C., 70° C., 80° C., 100° C., or 60° C., 80° C., 90° C., 110° C., or 70° C., 80° C., 90° C., 100° C., or 70° C., 90° C., 100° C., 120° C., or 70° C., 90° C., 110° C., 130° C., or 80° C., 90° C., 100° C., 110° C., or 80° C., 100° C., 120° C., 140° C., or 80° C., 100° C., 120° C., 150° C.

At the final stage of preparation, the device was covered with a transparent protective layer. In some variants of the invention, a gap may be provided between the protective layer and the base, or micro-holes may be provided in the transparent protective layer, allowing the gas phase to escape beyond the device after exceeding the recorded temperature. Preferably, the transparent protective layer is selected from transparent elastic polymers. In another variant of the invention, the device workpiece is kept at sub-atmospheric pressure and then covered with a transparent protective layer, ensuring the hermetic seal of the device and maintaining the sub-atmospheric pressure inside voids with the gas phase. For this purpose, in this variant of the invention, transparent elastic polymer films are also used as a protective layer.

### Operating Principle of the Device.

A device comprising a flexible base 3 and one or more heat-sensitive materials 1 applied to it and a transparent protective layer 4 is installed on the surface behind which temperature control must be ensured, ensuring a tight fit of the device, using fasteners provided by the design of the device. In a more preferred variant, the device is a sticker that is attached to the surface using an adhesive layer from which the insulating layer is first removed. In the other two variants (clip and cambric), the operating principle of the device is similar to the operating principle of the sticker.

Since devices for visually recording excess of temperature used in the electric power industry are mainly made in the form of stickers, then the operating principle of the device will be discussed below using a sticker as an example.

The device made in the form of a sticker with one applied heat-sensitive material operates as follows. The applied heat-sensitive material 1 in the original state and until it is heated to the threshold temperature is non-transparent to at least part of visible light and, in preferred variants of the invention, has a white color. Until the entire surface of the device or its individual sections located under the heat-sensitive material 1 is heated to the threshold temperature value, the heat-sensitive material 1 remains non-transparent to at least part of visible light, thereby preserving the original appearance of the device. When the surface of the heat-sensitive material 1 is heated above the threshold temperature, irreversible destruction of the microstructure of the heat-sensitive material 1 occurs on the entire surface of the heat-sensitive material 1 or predominantly on the heated section 11 of the heat-sensitive material 1, accompanied by the fusion of particles of solid organic substance 8, a decrease in the fraction of voids 9 and, as a consequence, an increase in transparency. In this case, the apparent density of the material increases. The heat-sensitive material 1 with modified microstructure is transparent and exhibits the color of the base 3 under this material or the color of the paint 7 applied to the base in the zone of the heat-sensitive material. Upon subsequent cooling of the controlled surface, the heat-sensitive material 1 or its part 11 remains transparent and the appearance of the device does not return to its original state. This ensures the possibility of visually recording the excess of temperature above the threshold temperature value, both at the moment of overheating and after a long period of time.

If the device has several (n) zones with heat-sensitive materials 1, having correspondingly different threshold temperatures T_{1 . . . n}, then until the surface of the equipment located under the heat-sensitive materials 1 is heated to the threshold temperature Ti, all heat-sensitive materials 1 remain non-transparent, thereby preserving the original appearance of the device. When the threshold temperature Ti is reached, the particles of solid organic substance of the first heat-sensitive material 1 having the threshold temperature Tᵢ lose their original shape and begin to fuse, and the microstructure begins to irreversibly deteriorate with a decrease in the fraction of voids and, as a consequence, an increase in the transparency of the corresponding heat-sensitive material 1 and the development of the color of the base 3 under it. At the same time, other zones with heat-sensitive materials 1 having activation temperatures T_{2 . . . n}>T₁ retain their microstructure and, as a consequence, their original appearance. Further increase in the temperature of the surface on which the device is placed to temperature T_{2 . . . n} will lead to sequential irreversible destruction of the microstructures of the corresponding heat-sensitive materials 1 with threshold temperatures T_{2 . . . n}. Moreover, if the maximum temperature of the equipment surface is lower than at least one of the threshold temperatures of heat-sensitive materials Tₙ, then the corresponding zones of heat-sensitive materials Tₙ will retain their microstructure and original non-transparency. Upon subsequent cooling of the equipment surfaces, the zones with heat-sensitive materials 1 with modified microstructure remain transparent and the appearance of the device does not return to its original state. When the equipment surface is reheated to the threshold temperature of previously untreated zones with heat-sensitive materials Tₙ with a given accuracy, the microstructure of the corresponding heat-sensitive materials 1 will be irreversibly destroyed with the “non-transparent-transparent” transition and the color of the base 3 will develop under them.

When the controlled surface is heated locally, the transparent zone 11 is formed only in that area of the heat-sensitive material that was subjected to heating above the threshold temperature, while maintaining a non-transparent area of the given material in its remaining zone that was not subjected to heating.

The numerical threshold temperature value 2 may be applied to the front side of the base 3; in particular cases, the threshold temperature value may be applied in a zone free of heat-sensitive materials 1, but next to them, or to the base 3 under the heat-sensitive materials 1, in the latter case, when the temperature exceeds the corresponding threshold temperature, after an irreversible change in the microstructure of the corresponding heat-sensitive material 1, the color of the base 3 and the numerical threshold temperature value 2 develop. In particular variants, the base may be black, and the heat-sensitive material in its original non-transparent state may be white. In this case, after the temperature exceeds the corresponding threshold temperature, a change in the appearance of the device is observed with a maximum “white-black” contrast, which additionally ensures the visibility of the operated device and facilitates its visual identification. A similar purpose is served by implementing a device in which the base has a color other than black, and black paint is applied to the zone under the heat-sensitive material 1, which is white in its original state. In this case, the “white-black” color transition is also observed when the device operates.

In the case of a device hermetically covered with an elastic transparent protective layer 4 at atmospheric pressure, at the moment of operation, as a result of the destruction of the microstructure of the heat-sensitive material 1 and the separation of gas and non-gas media, a bubble will form on the surface of the protective layer 4, which decreases as the device cools. When using a device with a hermetically sealed protective layer 4 and a pressure inside the voids 9 of the heat-sensitive material 1 below atmospheric pressure, the formation of a bubble on the surface of the protective layer 4 will not be observed when the threshold temperature is exceeded, due to the fact that the pressure of the gas phase inside the voids 9 is lower than atmospheric pressure in the original state, created at the stage of obtaining the device workpiece when applying the protective layer 4, compensates for the thermal expansion of the gas released during the destruction of the microstructure of the heat-sensitive material 1. In other variants of the device, to prevent the formation of a bubble when the threshold temperature is exceeded, a gap 5a or b can be made between the transparent protective layer and the base or micro-holes 5b can be made in the protective layer, providing, on the one hand, the possibility of escaping the gas released during operation.

The variants of the device, in which the temperature-sensitive material 1 comprises particles of solid organic substance 8, voids 9 and a binder 10, have a similar operating principle. When the temperature exceeds the corresponding threshold temperature, the particles 8 “glazed” with the binder 10 are fused, with the release of the gas phase and the separation of gas and non-gas media, which also results in irreversible destruction of the microstructure of the heat-sensitive material 1, accompanied by a decrease in the fraction of voids 9 and, as a consequence, an increase in the transparency of the material.

Thus, all variants of the device have an operating principle based on the irreversible destruction of the microstructure of the heat-sensitive material 1, accompanied by the fusion of particles of solid organic substance 8, a decrease in the fraction of voids 9 and, as a consequence, an increase in the transparency of the material and a change in the appearance of the device. Moreover, when the device cools, the appearance does not return to its original state.

Thus, during a visual inspection of the device, the fact that the temperature of the entire surface or its local area exceeds at least one threshold temperature value can be reliably and accurately recorded.

The preferred variants of the claimed device are presented below, which are illustrative and do not in any way limit the scope of the requested legal protection.

### EXAMPLES

### 1. Obtaining a Suspension of Solid Organic Substance in the Liquid Phase

The solid organic substance was crushed until the particle size reached 2-3 microns, the liquid phase was added and stirred, ensuring periodic dispersion of the mixture with air access, until a constant density of the mixture was obtained. A suspension of each resulting solid organic substance in the liquid phase was used for application immediately after it was obtained.

### 2. Obtaining a Suspension of Solid Organic Substance in the Liquid Phase with a Binder

The solid organic substance was crushed until the particle size reached 2-3 microns, a solution of the binder in the liquid phase was added and stirred, ensuring periodic dispersion of the mixture with air access, until a constant density of the mixture was obtained. A suspension of each resulting solid organic substance in the liquid phase was used for application immediately after it was obtained.

### 3. Method for Applying a Suspension of Solid Organic Substance in the Liquid Phase to a Base Using Sub-Atmospheric Pressure after Applying Each Layer

The area of the front surface of the base that should not come into contact with heat-sensitive material was sealed with polyethylene film. One layer of suspension of solid organic substance in the liquid phase, obtained according to example 1 or 2, was applied to the uncovered area of the base using a roller, the resulting layer was kept for at least 1 minute at a pressure of 10-300 mm Hg, as a result of which the liquid phase was partially or completely removed, then the application and drying procedure was repeated several times until the specified thickness of the layer of heat-sensitive material and the required hiding power were obtained, after which the protective film was removed and the resulting device was covered with a transparent polymer protective layer at atmospheric pressure.

### 4. Method for Applying a Suspension of Solid Organic Substance in the Liquid Phase to a Base Using Sub-Atmospheric Pressure after Applying all Layers

The area of the front surface of the base that should not come into contact with heat-sensitive material was sealed with polyethylene film. Several layers of suspension of solid organic substance in the liquid phase, obtained according to example 1 or 2, were successively applied to the uncovered area of the base using a roller until the specified thickness of the layer of heat-sensitive material and the required hiding power were obtained, without drying the layers between applications. The resulting workpiece was kept for at least 10 minutes at a pressure of 1-150 mm Hg, as a result of which the liquid phase was partially or completely removed, then the protective film was removed and the resulting device was covered with a transparent polymer protective layer at atmospheric pressure.

### 5. Method for Applying a Suspension of Solid Organic Substance in the Liquid Phase to a Base Using Sub-Atmospheric Pressure at the Stage of Coating with a Protective Layer

The area of the front surface of the base that should not come into contact with heat-sensitive material was sealed with polyethylene film. Several layers of suspension of solid organic substance in the liquid phase, obtained according to example 1 or 2, were successively applied to the uncovered area of the base using a roller until the specified thickness of the layer of heat-sensitive material and the required hiding power were obtained. Each layer was dried for at least 10 minutes in an air atmosphere before applying the next layer, as a result of which the liquid phase was partially or completely removed; after applying the last layer, the resulting workpiece was kept for at least 1 hour at atmospheric pressure, which also resulted in removal of the liquid phase from the top layer and in removal of the residual liquid phase from the previous layers. Then the protective film was removed and the resulting device was covered with a transparent polymer protective layer at a pressure of 200-650 mmHg, as a result of which the residual liquid phase was completely removed, and sub-atmospheric pressure was additionally formed in the resulting voids when covered with a protective layer.

### 6. Method for Applying a Suspension of Solid Organic Substance in the Liquid Phase to a Base Using Sub-Atmospheric Pressure after Applying all Layers and at the Stage of Coating with a Protective Layer

The area of the front surface of the base that should not come into contact with heat-sensitive material was sealed with polyethylene film. Several layers of suspension of solid organic substance in the liquid phase, obtained according to example 1 or 2, were successively applied to the uncovered area of the base using a roller until the specified thickness of the layer of heat-sensitive material and the required hiding power were obtained, without drying the layers between applications. The resulting workpiece was kept for at least 10 minutes at a pressure of 1-300 mmHg, as a result of which the liquid phase was partially or completely removed. Then the protective film was removed and the resulting device was covered with a transparent polymer protective layer at a pressure of 200-650 mmHg, and as a result of which the liquid phase was completely removed, and sub-atmospheric pressure was additionally formed in the resulting voids when covered with a protective layer.

### 7. Method for Applying a Suspension of Solid Organic Substance in the Liquid Phase to a Base Using Sub-Atmospheric Pressure at all Three Stages

The area of the front surface of the base that should not come into contact with heat-sensitive material was sealed with polyethylene film. One layer of suspension of solid organic substance in the liquid phase, obtained according to example 1 or 2, was applied to the uncovered area of the base using a roller, the resulting layer was kept for at least 1 minute at a pressure of 10-300 mm Hg, as a result of which the liquid phase was partially or completely removed, then the application and drying procedure was repeated several times until the specified thickness of the layer of heat-sensitive material and the required coverage were obtained. Then the resulting workpiece was kept for at least 10 minutes at a pressure of 30-200 mm Hg, as a result of which the residual liquid phase was completely removed, after which the protective film was removed and the resulting device was covered with a transparent polymer protective layer at a pressure of 200-650 mm Hg, as a result of which the liquid phase was completely removed, and sub-atmospheric pressure was additionally formed in the resulting voids when covered with a protective layer.

### 8. Method for Applying a Suspension of Solid Organic Substance in the Liquid Phase to a Base Using Tampon Printing

The area of the front surface of the base that should not come into contact with heat-sensitive material was sealed with polyethylene film. A tampon larger than the area to which the heat-sensitive material was applied was immersed in the suspension for 1 second, then the excess suspension was allowed to drain off. One layer of suspension of solid organic substance in the liquid phase, obtained according to example 1 or 2, was applied to the uncovered area of the base using a tampon, the resulting layer was kept for at least 10 minutes at atmospheric pressure, as a result of which the liquid phase was partially or completely removed, then the application and drying procedure was repeated several times until the specified thickness of the layer of heat-sensitive material and the required hiding power were obtained. The resulting workpiece was then dried for at least 1 hour at atmospheric pressure, as a result of which the residual liquid phase was completely removed, after which the protective film was removed and the resulting device was covered with a transparent polymer protective layer.

### 9. Method for Applying a Suspension of Solid Organic Substance in the Liquid Phase to a Base Using Flexographic Printing

The area of the front surface of the base that should not come into contact with heat-sensitive material was sealed with polyethylene film. The anilox roll was treated with the suspension, then the suspension was transferred from the anilox to a relief printing form whose convex parts are larger than the area to which the heat-sensitive material was applied. One layer of suspension of solid organic substance in the liquid phase, obtained according to example 1 or 2, was applied to the uncovered area of the base using a relief printing form, the resulting layer was kept for at least 10 minutes at atmospheric pressure, as a result of which the liquid phase was partially or completely removed, the application and drying procedure was repeated several times until the specified thickness of the layer of heat-sensitive material and the required hiding power were obtained. The resulting workpiece was then dried for at least 1 hour at atmospheric pressure, as a result of which the residual liquid phase was completely removed, after which the protective film was removed and the resulting device was covered with a transparent polymer protective layer.

### 10. Method for Applying a Suspension of Solid Organic Substance in the Liquid Phase to a Base Using Screen Printing

A screen form with a fine-meshed net, the dimensions of which correspond to the dimensions of the area to which the heat-sensitive material is applied, was fixed on the front surface of the base. The suspension of solid organic substance in the liquid phase, obtained according to example 1 or 2, was uniformly distributed over the screen form using a squeegee. The resulting layer was kept for at least 10 minutes at atmospheric pressure, as a result of which the liquid phase was partially or completely removed, then the application and drying procedure was repeated several times until the required number of layers of heat-sensitive material was obtained. The resulting workpiece was then dried for at least 1 hour at atmospheric pressure, as a result of which the residual liquid phase was completely removed, after which the protective film was removed and the resulting device was covered with a transparent polymer protective layer.

### 11. Determining the Hiding Power of Materials Obtained by Methods Claimed in this Group of Inventions

Substances of the class of alkanes (tetracosane), aliphatic acids (eicosanoic acid) and salts of aliphatic acids (lanthanum capronate) (100 g) were used as a solid organic substance; 100 g of isopropanol were used as a liquid phase; 100 g of a 3% solution of phenol formaldehyde resin in isopropanol were used as a binder. A suspension of each resulting solid organic substance in the liquid phase was used for application immediately after it was obtained.

To determine the hiding power, pre-weighed glass plates were used as a base. Suspensions of tetracosane and eicosanoic acid in isopropanol, obtained separately according to example 1, were applied to glass plates according to the methods described in examples 3, 4, 8-10, with the exception of the stage of applying a protective layer. A suspension of lanthanum capronate in isopropanol with the addition of phenol formaldehyde resin, obtained according to example 2, was applied to glass plates according to the methods described in examples 3, 4, 8-10, with the exception of the stage of applying a protective layer. The number of layers of suspension of the corresponding solid organic substance in the liquid phase on the samples obtained according to examples 3, 4 was 1, 3, 5, 7, 10, 15, 20, and on the samples obtained according to examples 8-10 was 3, 5, 7, 10, 15, 20. For each sample, the average thickness of the layer of applied heat-sensitive material was determined with an accuracy 1 micron and its mass—with an accuracy of 0.001 g, then the resulting plates with heat-sensitive material were placed on a contrast plate and observed in diffuse daylight whether the white and black fields were visible. The test results are shown in Tables 1-2.

Tables 1-2. Tests of the hiding power of materials obtained
by the methods claimed in this group of inventions

| | Application | Number of | | |
|---|---|---|---|---|
| Solid | method | layers of | Total | Is hiding |
| organic | according to | heat-sensitive | average layer | power |
| substance | example No. | material | thickness, μm | observed? |
| Tetracosan | 3 | 1 | 14 | No |
| | | 3 | 46 | No |
| | | 5 | 82 | Yes |
| | | 7 | 105 | Yes |
| | | 10 | 153 | Yes |
| | | 15 | 223 | Yes |
| | | 20 | 292 | Yes |
| | 4 | 1 | 21 | No |
| | | 3 | 76 | No |
| | | 5 | 112 | Yes |
| | | 7 | 171 | Yes |
| | | 10 | 230 | Yes |
| | | 15 | 318 | Yes |
| | | 20 | 437 | Yes |
| | 8 | 3 | 51 | Yes |
| | | 5 | 89 | Yes |
| | | 7 | 123 | Yes |
| | | 10 | 181 | Yes |
| | | 15 | 263 | Yes |
| | | 20 | 354 | Yes |
| | 9 | 3 | 69 | No |
| | | 5 | 116 | Yes |
| | | 7 | 168 | Yes |
| | | 10 | 226 | Yes |
| | | 15 | 342 | Yes |
| | | 20 | 451 | Yes |
| | 10 | 3 | 64 | Yes |
| | | 5 | 110 | Yes |
| | | 7 | 154 | Yes |
| | | 10 | 215 | Yes |
| | | 15 | 321 | Yes |
| | | 20 | 442 | Yes |
| Eicosanoic | 3 | 1 | 7 | No |
| acid | | 3 | 25 | No |
| | | 5 | 129 | Yes |
| | | 7 | 182 | Yes |
| | | 10 | 257 | Yes |
| | | 15 | 381 | Yes |
| | | 20 | 508 | Yes |
| | 4 | 1 | 11 | No |
| | | 3 | 36 | No |
| | | 5 | 61 | Yes |
| | | 7 | 86 | Yes |
| | | 10 | 132 | Yes |
| | | 15 | 184 | Yes |
| | | 20 | 246 | Yes |
| | 8 | 3 | 42 | No |
| | | 5 | 79 | Yes |
| | | 7 | 98 | Yes |
| | | 10 | 141 | Yes |
| | | 15 | 213 | Yes |
| | | 20 | 284 | Yes |
| | 9 | 3 | 38 | Yes |
| | | 5 | 69 | Yes |
| | | 7 | 92 | Yes |
| | | 10 | 141 | Yes |
| | | 15 | 198 | Yes |
| | | 20 | 263 | Yes |
| | 10 | 3 | 31 | No |
| | | 5 | 54 | Yes |
| | | 7 | 78 | Yes |
| | | 10 | 110 | Yes |
| | | 15 | 161 | Yes |
| | | 20 | 215 | Yes |

| | | Application | Number | Total | |
|---|---|---|---|---|---|
| | | method | of layers | average | |
| Solid | | according | of heat- | layer | Is hiding |
| organic | | to example | sensitive | thickness, | power |
| substance | Binder | No. | material | μm | observed? |
| Lantana | Phenol | 3 | 1 | 24 | No |
| capronate | formal- | | 3 | 78 | Yes |
| | dehyde | | 5 | 136 | Yes |
| | resin | | 7 | 185 | Yes |
| | | | 10 | 263 | Yes |
| | | | 15 | 389 | Yes |
| | | | 20 | 523 | Yes |
| | | 4 | 1 | 19 | No |
| | | | 3 | 63 | Yes |
| | | | 5 | 98 | Yes |
| | | | 7 | 142 | Yes |
| | | | 10 | 204 | Yes |
| | | | 15 | 251 | Yes |
| | | | 20 | 413 | Yes |
| | | 8 | 3 | 78 | Yes |
| | | | 5 | 138 | Yes |
| | | | 7 | 190 | Yes |
| | | | 10 | 258 | Yes |
| | | | 15 | 393 | Yes |
| | | | 20 | 529 | Yes |
| | | 9 | 3 | 59 | No |
| | | | 5 | 102 | Yes |
| | | | 7 | 149 | Yes |
| | | | 10 | 197 | Yes |
| | | | 15 | 258 | Yes |
| | | | 20 | 408 | Yes |
| | | 10 | 3 | 64 | Yes |
| | | | 5 | 97 | Yes |
| | | | 7 | 143 | Yes |
| | | | 10 | 206 | Yes |
| | | | 15 | 249 | Yes |
| | | | 20 | 420 | Yes |

During the test, it was established that the hiding power of heat-sensitive materials with solid organic substances of any of the selected classes, applied by any of the given methods, is achieved when the number of layers of heat-sensitive material is 3 or more and the thickness of the heat-sensitive material is 30 microns or more. 5

### 12. Determining the Hiding Power of Materials Obtained by Methods Known from the Prior Art

A solid organic substance of the class of alkanes (tetracosane), aliphatic acids (eicosanoic acid) and salts of aliphatic acids (lanthanum capronate) (100 g) was crushed in a ball mill for 30 hours until the particle size reached 2-3 μm, 100 g of isopropanol was added and stirred for another 10 hours. The mixture was not dispersed, unlike examples 1-2. A suspension of each resulting heat-sensitive material was used for application immediately after it was obtained.

To determine the hiding power, pre-weighed glass plates were used as a base. The area of the front surface of each glass plate that should not come into contact with heat-sensitive material was sealed with polyethylene film. Using a roller, the following was applied to the uncovered area of each glass plate: one layer of suspension to the first plate, five layers of suspension to the second plate, ten layers of suspension to the third plate, fifteen layers of suspension to the fourth plate, and twenty layers of suspension to the fifth plate. The layers were applied sequentially, without intermediate drying between the application of each layer; after applying the last layer of suspension of heat-sensitive material, the plates were dried in air at room temperature to constant weight. The average thickness of the layer of applied heat-sensitive material was determined with an accuracy of 1 micron and its mass—with an accuracy of 0.001 g, then the resulting plates with heat-sensitive material were placed on a contrast plate and observed in diffuse daylight whether the white and black fields were visible. The test results are shown in Table 3.

TABLE 3
Testing the hiding power of materials obtained
by method known from the prior art

| Solid | Number of layers | Total | Is hiding |
|---|---|---|---|
| organic | of heat-sensitive | average layer | power |
| substance | material | thickness, μm | observed? |
| Tetracosan | 1 | 125 | No |
| | 5 | 689 | No |
| | 10 | 1380 | No |
| | 15 | 1989 | No |
| | 20 | 2782 | Yes |
| Eicosanoic | 1 | 93 | No |
| acid | 5 | 512 | No |
| | 10 | 994 | No |
| | 15 | 1502 | No |
| | 20 | 2130 | Yes |
| Lantana | 1 | 142 | No |
| capronate | 5 | 839 | No |
| | 10 | 1638 | No |
| | 15 | 2232 | Yes |
| | 20 | 2898 | Yes |

During the test, it was established that the hiding power of heat-sensitive materials with solid organic substances of any of the selected classes is achieved when the number of layers of heat-sensitive material is equal to 20, and the thickness of the heat-sensitive material is more than 2100 microns.

### Examples 13-30. Manufacturing Specific Devices

### 13.

A suspension of tetracosane (100 g) with a phase transition temperature of 50° C. and 100 g of isopropanol was prepared according to example 1. The suspension was applied to a black OraJet 3951 PVC film with an adhesive layer, which is fire-resistant and has an electrical strength of at least 5 kV/mm, as well as flexibility and strength sufficient for installation and firm adhesion of the device to surfaces of complex geometry, with a thickness without an adhesive layer of 0.5 mm according to the method described in example 3 using a pressure of 10 mmHg. The thickness of the heat-sensitive material was 82 microns, and the total number of layers was 5. Micro-holes were made on the front surface of the protective layer. In its original state, the heat-sensitive material is white.

The device was installed at room temperature on a heating element, which was then heated in a controlled manner at a speed of 5° C./sec to a temperature of 50° C. with a given accuracy, the heating was stopped and the fact of the device's operation was registered by visually recording an increase in the transparency of the heat-sensitive material: when the set temperature was reached, an irreversible change in the microstructure of the heat-sensitive material occurred, as a result of which it became transparent, revealing the color of the base under it. The time during which the phase transition occurred and the transparency of the heat-sensitive material changed was 2 seconds. After subsequent cooling of the device to room temperature, it was visually recorded that the device retained its appearance and the transparency of the heat-sensitive material did not return to its original state.

### 14.

A suspension of yttrium capronate (100 g) with a phase transition temperature of 55° C., 100 g of methanol and 100 g of a 3% solution of phenol-formaldehyde resin in methanol was prepared according to example 2. The suspension was applied to a black OraJet 3106SG PVC film with an adhesive layer, which is fire-resistant and has an electrical strength of at least 5 kV/mm, as well as flexibility and strength sufficient for installation and firm adhesion of the device to surfaces of complex geometry, with a thickness without an adhesive layer of 0.8 mm according to the method described in example 4 using a pressure of 1 mm Hg. The thickness of the heat-sensitive material was 310 microns, and the total number of layers was 15. Micro-holes were made between the protective layer and the base. In its original state, the heat-sensitive material is white.

The device was installed at room temperature on a heating element, which was then heated in a controlled manner at a speed of 5° C./sec to a temperature of 55° C. with a given accuracy, the heating was stopped and the fact of the device's operation was registered by visually recording an increase in the transparency of the heat-sensitive material: when the set temperature was reached, an irreversible change in the microstructure of the heat-sensitive material occurred, as a result of which it became transparent, revealing the color of the base under it. The time during which the phase transition occurred and the transparency of the heat-sensitive material changed was 1 second. After subsequent cooling of the device to room temperature, it was visually recorded that the device retained its appearance and the transparency of the heat-sensitive material did not return to its original state.

### 15.

A suspension of palmitic acid anhydride (100 g) with a phase transition temperature of 60° C., 100 g of 1-propanol and 100 g of a 1% solution of butyl methacrylic resin in 1-propanol was prepared according to example 2. The suspension was applied to a black polyurethane film 3981RA with an adhesive layer, having a thickness without an adhesive layer of 0.2 mm, according to the method described in example 5 using a pressure of 200 mm Hg. The thickness of the heat-sensitive material was 428 microns, and the total number of layers was 20. In its original state, the heat-sensitive material is white.

The device was installed at room temperature on a heating element, which was then heated in a controlled manner at a speed of 5° C./sec to a temperature of 60° C. with a given accuracy, the heating was stopped and the fact of the device's operation was registered by visually recording an increase in the transparency of the heat-sensitive material: when the set temperature was reached, an irreversible change in the microstructure of the heat-sensitive material occurred, as a result of which it became transparent, revealing the color of the base under it. The time during which the phase transition occurred and the transparency of the heat-sensitive material changed was 2 seconds. After subsequent cooling of the device to room temperature, it was visually recorded that the device retained its appearance and the transparency of the heat-sensitive material did not return to its original state.

### 16.

A suspension of eicosanoic acid (100 g) with a phase transition temperature of 70° C., 100 g of isobutanol and 100 g of a 10% solution of melamine-formaldehyde resin in isobutanol was prepared according to example 2. The suspension was applied to a polyester film 3M: 50/RC20/HD70WH yellow with an adhesive layer, having a thickness without an adhesive layer of 0.4 mm, according to the method described in example 6 using a pressure of 1 mm Hg after applying all layers and 200 mm Hg-before coating with a protective layer, and black paint was applied to the uncovered area of the base using solvent dyes before applying the suspension. The thickness of the heat-sensitive material was 195 microns, and the total number of layers was 10. In its original state, the heat-sensitive material is white and completely covers the black paint applied to the base.

The device was installed at room temperature on a heating element, which was then heated in a controlled manner at a speed of 5° C./sec to a temperature of 70° C. with a given accuracy, the heating was stopped and the fact of the device's operation was registered by visually recording an increase in the transparency of the heat-sensitive material: when the set temperature was reached, an irreversible change in the microstructure of the heat-sensitive material occurred, as a result of which it became transparent, revealing the color of the base under it. The time during which the phase transition occurred and the transparency of the heat-sensitive material changed was 3 seconds. After subsequent cooling of the device to room temperature, it was visually recorded that the device retained its appearance and the transparency of the heat-sensitive material did not return to its original state.

### 17.

A suspension of oleamide (100 g) with a phase transition temperature of 75° C., 100 g of ethylene glycol monomethyl ether and 100 g of a 15% solution of polyvinyl butyral in ethylene glycol monomethyl ether was prepared according to example 2. The suspension was applied to a polyester film 3M: WHITEV TC black with an adhesive layer, having a thickness without an adhesive layer of 0.4 mm, according to the method described in example 7 using a pressure of 1 mm Hg after applying each layer, 30 mm Hg—after applying all layers, and 200 mm Hg—before coating with a protective layer. The thickness of the heat-sensitive material was 119 microns, and the total number of layers was 7. In its original state, the heat-sensitive material is white.

The device was installed at room temperature on a heating element, which was then heated in a controlled manner at a speed of 5° C./sec to a temperature of 75° C. with a given accuracy, the heating was stopped and the fact of the device's operation was registered by visually recording an increase in the transparency of the heat-sensitive material: when the set temperature was reached, an irreversible change in the microstructure of the heat-sensitive material occurred, as a result of which it became transparent, revealing the color of the base under it. The time during which the phase transition occurred and the transparency of the heat-sensitive material changed was 3 seconds. After subsequent cooling of the device to room temperature, it was visually recorded that the device retained its appearance and the transparency of the heat-sensitive material did not return to its original state.

### 18.

A suspension of 1-docosanol (100 g) with a phase transition temperature of 70° C., 100 g of 1-butanol and 100 g of a 25% solution of polybutyl methacrylate in 1-butanol was prepared according to example 2. The suspension was applied to a polyester film 3M: 7874 E black with an adhesive layer, having a thickness without an adhesive layer of 0.4 mm, according to the method described in example 8. The thickness of the heat-sensitive material was 52 microns, and the total number of layers was 5. In its original state, the heat-sensitive material is white.

The device was installed at room temperature on a heating element, which was then heated in a controlled manner at a speed of 5° C./sec to a temperature of 70° C. with a given accuracy, the heating was stopped and the fact of the device's operation was registered by visually recording an increase in the transparency of the heat-sensitive material: when the set temperature was reached, an irreversible change in the microstructure of the heat-sensitive material occurred, as a result of which it became transparent, revealing the color of the base under it. The time during which the phase transition occurred and the transparency of the heat-sensitive material changed was 4 seconds. After subsequent cooling of the device to room temperature, it was visually recorded that the device retained its appearance and the transparency of the heat-sensitive material did not return to its original state.

### 19.

A suspension of dioctadecylamine (100 g) with a phase transition temperature of 70° C., 100 g of acetonitrile and 100 g of a 30% solution of polybutyl acrylate in acetonitrile was prepared according to example 2. The suspension was applied to a yellow ORALITE 5500 methyl methacrylate film with an adhesive layer, having a thickness without an adhesive layer 0.4 mm, according to the method described in example 9, and black paint containing the numeric threshold temperature value was applied to the uncovered area of the base using solvent dyes before applying the suspension. The thickness of the heat-sensitive material was 39 microns, and the total number of layers was 3. In its original state, the heat-sensitive material is white.

The device was installed at room temperature on a heating element, which was then heated in a controlled manner at a speed of 5° C./sec to a temperature of 70° C. with a given accuracy, the heating was stopped and the fact of the device's operation was registered by visually recording an increase in the transparency of the heat-sensitive material: when the set temperature was reached, an irreversible change in the microstructure of the heat-sensitive material occurred, as a result of which it became transparent, revealing the color of the base under it, as well as the numerical threshold temperature value. The time during which the phase transition occurred and the transparency of the heat-sensitive material changed was 4 seconds. After subsequent cooling of the device to room temperature, it was visually recorded that the device retained its appearance and the transparency of the heat-sensitive material did not return to its original state.

### 20.

A suspension of solid organic substance (100 g), 100 g of acetic acid and 100 g of a 3% solution of binder in acetic acid was prepared according to example 2. The following solid organic substances were used: dioctylphosphinic acid with a phase transition temperature of 80° C., yttrium behenate with with a phase transition temperature of 90° C., lanthanum palmitate with a phase transition temperature of 100° C. Polyethylene, polyvinyl chloride, and polycarbonate were used as binders. The suspensions were applied to a yellow Optibelt elastomeric film with an adhesive layer, having a thickness without an adhesive layer of 0.4 mm, according to the method described in example 10, and black paint was applied to the uncovered area of the base using solvent dyes before applying the suspension. Each suspension of solid organic substance in the liquid phase was applied to a separate section of the base. The thickness of the heat-sensitive materials was 328, 406, 394 microns, respectively, and the number of layers of each material was 15. In their original state, the heat-sensitive materials are white. The device was installed at room temperature on a heating element, which was then heated in a controlled manner at a speed of 5° C./sec to a temperature of 80° C. with a given accuracy, the heating was stopped and the fact of the device's operation was registered by visually recording an increase in the transparency of the heat-sensitive material: when the set temperature was reached, an irreversible change in the microstructure of the heat-sensitive material occurred, as a result of which it became transparent, revealing the color of the base under it. The time during which the phase transition occurred and the transparency of the first heat-sensitive material changed was 2 seconds. After subsequent cooling of the device to room temperature, it was visually recorded that the device retained its appearance and the transparency of the heat-sensitive material did not return to its original state. Cycles of heating to temperatures of 90° C. H 100° C. and subsequent cooling to room temperature were repeated. The change in transparency of the corresponding zone of the heat-sensitive material was recorded after each cycle. The time during which the phase transition occurred and the transparency of the second heat-sensitive material changed was 2 seconds, and of the third temperature-sensitive material—1 second. After the final cooling of the device to room temperature, the preservation of transparency of all zones with heat-sensitive materials was visually recorded.

### 21.

A suspension of solid organic substance (100 g), 100 g of 1,1,1-trifluoroethanol and 100 g of a 3% solution of binder in 1,1,1-trifluoroethanol was prepared according to example 2. The following solid organic substances were used: lanthanum nonadecynate with a phase transition temperature of 110 C, lanthanum capronate with a phase transition temperature of 120° C., zinc nonadecanoate with a phase transition temperature of 130° C., zinc palmitate with a phase transition temperature of 140° C. Polyester, polymethacrylate, gelatin, and ethylcellulose were used as binders. The suspensions were applied to red Aurora self-adhesive fabric with an adhesive layer, having a thickness without an adhesive layer of 0.4 mm, according to the method described in example 10, and black paint was applied to the uncovered area of the base using solvent dyes before applying the suspension, as well as the numerical threshold temperature values were applied to the front surface of the base in zones free of heat-sensitive materials. Each suspension of solid organic substance in the liquid phase was applied to a separate section of the base. The thickness of the heat-sensitive materials was 53, 39, 43 microns, respectively, and the number of layers of each material was 3. In their original state, the heat-sensitive materials are white.

The device was installed at room temperature on a heating element, which was then heated in a controlled manner at a speed of 5° C./sec to a temperature of 110° C. with a given accuracy, the heating was stopped and the fact of the device's operation was registered by visually recording an increase in the transparency of the heat-sensitive material: when the set temperature was reached, an irreversible change in the microstructure of the heat-sensitive material occurred, as a result of which it became transparent, revealing the color of the base under it. The time during which the phase transition occurred and the transparency of the first heat-sensitive material changed was 2 seconds. After subsequent cooling of the device to room temperature, it was visually recorded that the device retained its appearance and the transparency of the heat-sensitive material did not return to its original state. Cycles of heating to temperatures of 120° C., 130° C. H 140° C. and subsequent cooling to room temperature were repeated. The change in transparency of the corresponding zone of the heat-sensitive material was recorded after each cycle. The time during which the phase transition occurred and the transparency of the second temperature-sensitive material changed was 1 second, of the third temperature-sensitive material—2 seconds, and of the fourth temperature-sensitive material—1 second. After the final cooling of the device to room temperature, the preservation of transparency of all zones with heat-sensitive materials was visually recorded.

### 22.

A suspension of solid organic substance (100 g), 100 g of 1,1, 1,3,3,3-hexafluoroisopropanol and 100 g of a 3% solution of binder in 1, 1,1, 3,3,3-hexafluoroisopropanol was prepared according to example 2. The following solid organic substances were used: n-docosylamine with a phase transition temperature of 65° C., tetracontane with a phase transition temperature of 80° C., didecylphosphinic acid with a phase transition temperature of 90° C. Phenoxy resin, polyethersulfone, and polypropylene were used as binders. The suspensions were applied to red Silicraft siliconized cardboard with an adhesive layer, having a thickness without an adhesive layer of 0.4 mm, according to the method described in example 7 using a pressure of 150 mmHg after applying each layer, 100 mm Hg after applying all layers, and 450 mm Hg before coating with a protective layer, and black paint was applied to the uncovered area of the base using solvent dyes before applying the suspension, as well as the numerical threshold temperature values were applied to the front surface of the base in zones free of heat-sensitive materials. Each suspension of solid organic substance in the liquid phase was applied to a separate section of the base. The thickness of the heat-sensitive materials was 387, 472, 434 microns, respectively, and the number of layers of each material was 15. In their original state, the heat-sensitive materials are white.

The device was installed at room temperature on a heating element, which was then heated in a controlled manner at a speed of 5° C./sec to a temperature of 65° C. with a given accuracy, and the fact of operation of the corresponding zone of the device was registered by visually recording an increase in the transparency of the heat-sensitive material. Next, the heating element was immediately heated in a controlled manner at a speed of 5° C./sec to a temperature of 80° C. with a given accuracy, the fact of operation of another corresponding zone of the device was recorded in a similar manner, then the heating element was immediately heated in a controlled manner at a speed of 5° C./sec to a temperature of 90° C. with a given accuracy and the fact of operation of the third corresponding zone of the device was recorded. After cooling the device to room temperature, the preservation of transparency of all zones with heat-sensitive materials was visually recorded.

### 23.

A suspension of zinc capronate (100 g) with a phase transition temperature of 150° C. and 100 g of dimethyl formamide was prepared according to example 1. The suspension was applied to a black PVC tube with a diameter of 3 mm, which is fire-resistant and has an electrical strength of at least 5 kV/mm, as well as flexibility and strength, with a thickness of 0.5 mm according to the method described in example 4 using a pressure of 300 mm Hg. The thickness of the heat-sensitive material was 522 microns, and the total number of layers was 20. In its original state, the heat-sensitive material is white.

The device was installed at room temperature on a heating element, which was then heated in a controlled manner at a speed of 5° C./sec to a temperature of 150° C. with a given accuracy, the heating was stopped and the fact of the device's operation was registered by visually recording an increase in the transparency of the heat-sensitive material: when the set temperature was reached, an irreversible change in the microstructure of the heat-sensitive material occurred, as a result of which it became transparent, revealing the color of the base under it. The time during which the phase transition occurred and the transparency of the heat-sensitive material changed was 2 seconds. After subsequent cooling of the device to room temperature, it was visually recorded that the device retained its appearance and the transparency of the heat-sensitive material did not return to its original state.

### 24.

A suspension of lithium stearate (100 g) with a phase transition temperature of 210° C. and 100 g of a mixture of ethanol and water (50/50 vol. %) was prepared according to example 1. The suspension was applied to a white PVC cable clip with a diameter of 5 mm, which is fire-resistant and has an electrical strength of at least 5 kV/mm, as well as flexibility and strength, with a thickness of 1 mm according to the method described in example 5 using a pressure of 650 mm Hg, and black paint was applied to the uncovered area of the base using solvent dyes before applying the suspension. The thickness of the heat-sensitive material was 84 microns, and the total number of layers was 5. In its original state, the heat-sensitive material is white.

The device was installed at room temperature on a heating element, which was then heated in a controlled manner at a speed of 5° C./sec to a temperature of 210° C. with a given accuracy, the heating was stopped and the fact of the device's operation was registered by visually recording an increase in the transparency of the heat-sensitive material: when the set temperature was reached, an irreversible change in the microstructure of the heat-sensitive material occurred, as a result of which it became transparent, revealing the color of the base under it. The time during which the phase transition occurred and the transparency of the heat-sensitive material changed was 2 seconds. After subsequent cooling of the device to room temperature, it was visually recorded that the device retained its appearance and the transparency of the heat-sensitive material did not return to its original state.

### 25.

A suspension of stearic acid (100 g) with a phase transition temperature of 70° C., 100 g of butyl acetate and 100 g of a 30% solution of polybutyl acrylate in butyl acetate was prepared according to example 2. The suspension was applied to a yellow ORALITE 5500 methyl methacrylate film with an adhesive layer, having a thickness without an adhesive layer of 0.4 mm, according to the method described in example 6 using a pressure of 300 mm Hg after applying all layers and 650 mm after applying the protective layer, and black paint containing the numerical threshold temperature value was applied to the uncovered area of the base using solvent dyes before applying the suspension. The thickness of the heat-sensitive material was 680 microns, and the total number of layers was 26. In its original state, the heat-sensitive material is white.

The device was installed at room temperature on a heating element, which was then heated in a controlled manner at a speed of 5° C./sec to a temperature of 70° C. with a given accuracy, the heating was stopped and the fact of the device's operation was registered by visually recording an increase in the transparency of the heat-sensitive material: when the set temperature was reached, an irreversible change in the microstructure of the heat-sensitive material occurred, as a result of which it became transparent, revealing the color of the base under it, as well as the numerical threshold temperature value. The time during which the phase transition occurred and the transparency of the heat-sensitive material changed was 3 seconds. After subsequent cooling of the device to room temperature, it was visually recorded that the device retained its appearance and the transparency of the heat-sensitive material did not return to its original state.

### 26.

A suspension of behenic acid (100 g) with a phase transition temperature of 80° C., 100 g of acetone and 100 g of a 30% solution of polyvinylidene fluoride in acetone was prepared according to example 2. The suspension was applied to a yellow ORALITE 5500 methyl methacrylate film with an adhesive layer, having a thickness without an adhesive layer of 0.4 mm, according to the method described in example 7 using a pressure of 300 mm Hg after applying each layer, 200 mm Hg after applying all layers and 650 mm Hg before coating with a protective layer, and black paint containing the numeric threshold temperature value was applied to the uncovered area of the base using solvent dyes before applying the suspension. The thickness of the heat-sensitive material was 282 microns, and the total number of layers was 10. In its original state, the heat-sensitive material is white.

The device was installed at room temperature on a heating element, which was then heated in a controlled manner at a speed of 5° C./sec to a temperature of 80° C. with a given accuracy, the heating was stopped and the fact of the device's operation was registered by visually recording an increase in the transparency of the heat-sensitive material: when the set temperature was reached, an irreversible change in the microstructure of the heat-sensitive material occurred, as a result of which it became transparent, revealing the color of the base under it, as well as the numerical threshold temperature value. The time during which the phase transition occurred and the transparency of the heat-sensitive material changed was 2 seconds. After subsequent cooling of the device to room temperature, it was visually recorded that the device retained its appearance and the transparency of the heat-sensitive material did not return to its original state.

### 27.

A suspension of erucamide (100 g) with a phase transition temperature of 75° C. and 100 g of hexane was prepared according to example 1. The suspension was applied to a yellow ORALITE 5500 methyl methacrylate film with an adhesive layer, having a thickness without an adhesive layer of 0.4 mm, according to the method described in example 4 using a pressure of 150 mm Hg, and black paint containing the numeric threshold temperature value was applied to the uncovered area of the base using solvent dyes before applying the suspension. The thickness of the heat-sensitive material was 429 microns, and the total number of layers was 17. In its original state, the heat-sensitive material is white.

The device was installed at room temperature on a heating element, which was then heated in a controlled manner at a speed of 5° C./sec to a temperature of 75° C. with a given accuracy, the heating was stopped and the fact of the device's operation was registered by visually recording an increase in the transparency of the heat-sensitive material: when the set temperature was reached, an irreversible change in the microstructure of the heat-sensitive material occurred, as a result of which it became transparent, revealing the color of the base under it, as well as the numerical threshold temperature value. The time during which the phase transition occurred and the transparency of the heat-sensitive material changed was 4 seconds. After subsequent cooling of the device to room temperature, it was visually recorded that the device retained its appearance and the transparency of the heat-sensitive material did not return to its original state.

### 28.

A suspension of stearic alcohol (100 g) with a phase transition temperature of 60° C. and 100 g of heptane was prepared according to example 1. The suspension was applied to a yellow ORALITE 5500 methyl methacrylate film with an adhesive layer, having a thickness without an adhesive layer of 0.4 mm, according to the method described in example 3 using a pressure of 300 mm Hg, and black paint containing the numeric threshold temperature value was applied to the uncovered area of the base using solvent dyes before applying the suspension. The thickness of the heat-sensitive material was 61 microns, and the total number of layers was 4. In its original state, the heat-sensitive material is white.

The device was installed at room temperature on a heating element, which was then heated in a controlled manner at a speed of 5° C./sec to a temperature of 60° C. with a given accuracy, the heating was stopped and the fact of the device's operation was registered by visually recording an increase in the transparency of the heat-sensitive material: when the set temperature was reached, an irreversible change in the microstructure of the heat-sensitive material occurred, as a result of which it became transparent, revealing the color of the base under it, as well as the numerical threshold temperature value. The time during which the phase transition occurred and the transparency of the heat-sensitive material changed was 4 seconds. After subsequent cooling of the device to room temperature, it was visually recorded that the device retained its appearance and the transparency of the heat-sensitive material did not return to its original state.

### 29.

A suspension of cetyl alcohol (100 g) with a phase transition temperature of 50° C., 100 g of toluene and 100 g of a 30% solution of nitrocellulose in toluene was prepared according to example 2. The suspension was applied to a yellow ORALITE 5500 methyl methacrylate film with an adhesive layer, having a thickness without an adhesive layer of 0.4 mm, according to the method described in example 5 using a pressure of 450 mm Hg, and black paint containing the numeric threshold temperature value was applied to the uncovered area of the base using solvent dyes before applying the suspension. The thickness of the heat-sensitive material was 92 microns, and the total the number of layers was 8. In its original state, the heat-sensitive material is white.

The device was installed at room temperature on a heating element, which was then heated in a controlled manner at a speed of 5° C./sec to a temperature of 50° C. with a given accuracy, the heating was stopped and the fact of the device's operation was registered by visually recording an increase in the transparency of the heat-sensitive material: when the set temperature was reached, an irreversible change in the microstructure of the heat-sensitive material occurred, as a result of which it became transparent, revealing the color of the base under it, as well as the numerical threshold temperature value. The time during which the phase transition occurred and the transparency of the heat-sensitive material changed was 1 second. After subsequent cooling of the device to room temperature, it was visually recorded that the device retained its appearance and the transparency of the heat-sensitive material did not return to its original state.

### 30.

A suspension of dispersed polyethylene (100 g) with a phase transition temperature of 110° C., 100 g of o-xylene and 100 g of a 30% solution of polycaprolactone in o-xylene was prepared according to example 2. The suspension was applied to a yellow ORALITE 5500 methyl methacrylate film with an adhesive layer, having a thickness without an adhesive layer of 0.4 mm, according to the method described in example 3 using a pressure of 150 mm Hg, and black paint containing the numeric threshold temperature value was applied to the uncovered area of the base using solvent dyes before applying the suspension. The thickness of the heat-sensitive material was 252 microns, and the total number of layers was 13. In its original state, the heat-sensitive material is white.

The device was installed at room temperature on a heating element, which was then heated in a controlled manner at a speed of 5° C./sec to a temperature of 110° C. with a given accuracy, the heating was stopped and the fact of the device's operation was registered by visually recording an increase in the transparency of the heat-sensitive material: when the set temperature was reached, an irreversible change in the microstructure of the heat-sensitive material occurred, as a result of which it became transparent, revealing the color of the base under it, as well as the numerical threshold temperature value. The time during which the phase transition occurred and the transparency of the heat-sensitive material changed was 2 seconds. After subsequent cooling of the device to room temperature, it was visually recorded that the device retained its appearance and the transparency of the heat-sensitive material did not return to its original state.

### 31.

A suspension of dotriacontan-1-ol (100 g) with a phase transition temperature of 90° C. and 100 g of a mixture of ethanol and water (50/50 vol. %) was prepared according to example 1. The suspension was applied to a yellow OraJet 3951 PVC film with an adhesive layer, having a thickness without an adhesive layer of 0.3 mm, according to the method described in example 6 using a pressure of 150 mm Hg after applying all layers and 450 mm before coating with a protective layer, and black paint containing the numerical threshold temperature value was applied to the uncovered area of the base using solvent dyes before applying the suspension. The thickness of the heat-sensitive material was 452 microns, and the total number of layers was 18. In its original state, the heat-sensitive material is white.

The device was installed at room temperature on a heating element, which was then heated in a controlled manner at a speed of 5° C./sec to a temperature of 90° C. with a given accuracy, the heating was stopped and the fact of the device's operation was registered by visually recording an increase in the transparency of the heat-sensitive material: when the set temperature was reached, an irreversible change in the microstructure of the heat-sensitive material occurred, as a result of which it became transparent, revealing the color of the base under it. The time during which the phase transition occurred and the transparency of the heat-sensitive material changed was 2 seconds. After subsequent cooling of the device to room temperature, it was visually recorded that the device retained its appearance and the transparency of the heat-sensitive material did not return to its original state.

### 32.

A suspension of a solid organic substance (100 g), 100 g of isopropanol and 100 g of a 3% solution of binder in isopropanol was prepared according to example 2. The following solid organic substances were used: tridecane anhydride with a phase transition temperature of 50°, docosanitrile with a phase transition temperature of 55° C., palmitic acid with a phase transition temperature of 60° C. Polyethylene, polyvinyl chloride, and polycarbonate were used as binders. The suspensions were applied to a yellow Optibelt elastomeric film with an adhesive layer, having a thickness without an adhesive layer of 0.4 mm, according to the method described in example 10, and black paint was applied to the uncovered area of the base using solvent dyes before applying the suspension. Each suspension of solid organic substance in the liquid phase was applied to a separate section of the base. The thickness of the heat-sensitive materials was 328, 406, 394 microns, respectively, and the number of layers of each material was 15. In their original state, the heat-sensitive materials are white. The device was installed at room temperature on a heating element, which was then heated in a controlled manner at a speed of 5° C./sec to a temperature of 50° C. with a given accuracy, the heating was stopped and the fact of the device's operation was registered by visually recording an increase in the transparency of the heat-sensitive material: when the set temperature was reached, an irreversible change in the microstructure of the heat-sensitive material occurred, as a result of which it became transparent, revealing the color of the base under it. The time during which the phase transition occurred and the transparency of the first heat-sensitive material changed was 1 second. After subsequent cooling of the device to room temperature, it was visually recorded that the device retained its appearance and the transparency of the heat-sensitive material did not return to its original state. Cycles of heating to temperatures of 55° C. and 60° C. and subsequent cooling to room temperature were repeated. The change in transparency of the corresponding zone of the heat-sensitive material was recorded after each cycle. The time during which the phase transition occurred and the transparency of the second heat-sensitive material changed was 3 seconds, and of the third temperature-sensitive material—1 second. After the final cooling of the device to room temperature, the preservation of transparency of all zones with heat-sensitive materials was visually recorded.

### 33. Long-Term Exposure of the Device at a Temperature Close to the Threshold Temperature

The device according to example 22 was installed at room temperature on a heating element, which was then heated in a controlled manner at a speed of 5° C./sec to a temperature of 140° C. and held at this temperature for 10 hours. Then the heating was stopped and the preservation of the original appearance of the device was recorded: the heat-sensitive material did not change its transparency. Upon subsequent cooling of the device to room temperature, there was also no change in the transparency of the heat-sensitive material, and the appearance of the device remained in its original state.

Next, the device was heated in a controlled manner at a speed of 5° C./sec to a temperature of 150° C. with a given accuracy and the fact of the device's operation was registered by visually recording an increase in the transparency of the heat-sensitive material: when the set temperature was reached, an irreversible change in the microstructure of the heat-sensitive material occurred, as a result of which it became transparent, revealing the color of the base under it. After subsequent cooling of the device to room temperature, it was visually recorded that the device retained its appearance and the transparency of the heat-sensitive material did not return to its original state.

Next, the operated device was placed in a refrigeration chamber with a temperature set at −20° C., kept at this temperature for 10 hours, and the preservation of the transparency of the heat-sensitive material was recorded after this time, as well as after bringing the temperature of the device to room temperature. Thus, it was established that the device retains its original state at a temperature close to the threshold temperature before operation, and after operation, it does not return to its original state even after prolonged exposure at a low temperature.

1. The device for visually recording the excess of temperature above at least one threshold value, having a layered structure including:
a base that is non-transparent to at least part of visible light, on the front surface of which inscriptions are applied indicating at least one numerical threshold temperature value;
at least one heat-sensitive material that is non-transparent to at least part of visible light, applied to individual sections of the base, the microstructure of which includes particles of solid organic substance and voids filled with the gas phase;
a transparent protective layer that partially or completely covers the front surface of the device;
in this case, the device is designed with the ability to irreversibly change its appearance upon reaching at least one threshold temperature indicated on it due to the destruction of the microstructure of the corresponding heat-sensitive material, accompanied by the fusion of particles of solid organic substance, a decrease in the fraction of voids and an increase in its transparency with the development of the color of the base.

2. The device according to claim 1, wherein the pressure of the gas phase inside the voids of the heat-sensitive material is lower than atmospheric pressure.

3. The device according to claim 1, wherein a gap is made between the transparent protective layer and the base or micro-holes are made in the protective layer, allowing the gas contained in the voids to escape beyond the device after exceeding the recorded temperature.

4. The device according to claim 1, wherein in the microstructure of at least one heat-sensitive material in the original state, the particles of solid organic substance are predominantly oriented parallel to the plane of the surface of the base and protective coating.

5. The device according to claim 1, wherein the fraction of voids of at least one heat-sensitive material after heating above the corresponding threshold temperature value decreases by at least 2 times.

6. The device according to claim 1, wherein the solid organic substance of the heat-sensitive material(s) is selected from the group: fatty aliphatic acids containing at least 13 carbon atoms; salts of fatty aliphatic acids containing at least 12 carbon atoms; alkanes containing at least 20 carbon atoms; dialkylphosphinic acids containing at least 16 carbon atoms; amides of fatty aliphatic acids containing at least 3 carbon atoms; anhydrides of fatty aliphatic acids containing at least 22 carbon atoms; fatty aliphatic alcohols containing at least 16 carbon atoms; fatty aliphatic amines containing at least 17 carbon atoms; nitriles of fatty aliphatic acids containing at least 20 carbon atoms or mixtures thereof.

7. The device according to claim 1, wherein the solid organic substance of the heat-sensitive material(s) is selected from the group: palmitic acid, stearic acid, behenic acid, tetracosane, erucamide, stearic alcohol, cetyl alcohol, dispersed polyethylene, salts of saturated fatty carboxylic acids of rare earth metals, in particular lanthanum, yttrium, ytterbium, scandium.

8. The device according to claim 1, wherein the microstructure of at least one heat-sensitive material additionally contains a polymer binder that is transparent to at least part of visible light in an amount of 1-30 wt. %.

9. The device according to claim 1, wherein it is made in the form of a sticker including an insulating layer, an adhesive layer, an clastic base that is non-transparent to at least part of visible light, made of halogen-containing polymers, having a thickness of less than 1 mm and a dielectric strength of at least 5 kV/mm, at least one heat-sensitive material applied to individual sections of the base, with a thickness of not more than 800 microns, in which the heat-sensitive material is designed with the possibility of an irreversible change in transparency upon reaching the corresponding threshold temperature indicated on the device, in a time of less than 5 seconds.

10. The device according to claim 1, wherein it is made in the form of an clastic hollow tube intended for putting on wires, the surface of which acts as a base that is non-transparent to at least part of visible light, made of halogen-containing polymers, having a thickness of less than 1 mm and dielectric strength of at least 5 kV/mm, on individual sections of the front surface of which at least one heat-sensitive material with a thickness of not more than 800 microns is applied, in which the heat-sensitive material is designed with the possibility of an irreversible change in transparency upon reaching the corresponding threshold temperature indicated on the device, in a time of less than 5 seconds.

11. The device according to claim 1, wherein it is made in the form of a tube including a longitudinal cut and intended for fastening to wires, the surface of which acts as a base that is non-transparent to at least part of visible light, made of halogen-containing polymers, having a thickness of less than 1 mm and a dielectric strength of at least 5 kV/mm, on individual sections of the front surface of which at least one heat-sensitive material with a thickness of not more than 800 microns is applied, in which the heat-sensitive material is designed with the possibility of an irreversible change in transparency upon reaching the corresponding threshold temperature indicated on the device, in a time of less than 5 seconds.

12. The device according to claim 9, wherein the base has reflective or luminescent properties.

13. The device according to claim 9, wherein the surface area of the base covered with at least one heat-sensitive material is at least 100 mm².

14. The device according to claim 1, wherein it is designed with the ability to register point heating of the controlled surface by changing the transparency of only that area of the heat-sensitive material that was subjected to heating above the threshold temperature.

15. The method for manufacturing the device for visually recording the excess of temperature above at least one threshold value according to claim 1, including the following steps:
applying to individual sections of the non-transparent base one or more layers of at least one suspension of particles of solid organic substance in the liquid phase, the boiling temperature of which is less than 180° C., wherein the solubility of particles of solid organic substance in the liquid phase does not exceed 10 g/kg;
removing the liquid phase from the applied layers of suspension of particles of solid organic substance in the liquid phase to form a heat-sensitive material that is non-transparent to at least part of visible light, the microstructure of which includes particles of solid organic substance and voids filled with the gas phase;
covering the front surface of the workpiece with a transparent protective layer, in which at least one of the above steps is carried out at sub-atmospheric pressure.

16. The method according to claim 15, wherein the base includes halogen-containing polymers.

17. The method according to claim 15, wherein the solid organic substance of the heat-sensitive material(s) is selected from the group: fatty aliphatic acids containing at least 13 carbon atoms; salts of fatty aliphatic acids containing at least 12 carbon atoms; alkanes containing at least 20 carbon atoms; dialkylphosphinic acids containing at least 16 carbon atoms; amides of fatty aliphatic acids containing at least 3 carbon atoms; anhydrides of fatty aliphatic acids containing at least 22 carbon atoms; fatty aliphatic alcohols containing at least 16 carbon atoms; fatty aliphatic amines containing at least 17 carbon atoms; nitriles of fatty aliphatic acids containing at least 20 carbon atoms or mixtures thereof.

18. The method for manufacturing the device for visually recording the excess of temperature above at least one threshold value according to claim 1, including performing at least 3 cycles, each of which includes applying a layer of at least one suspension of particles of solid organic substance in the liquid phrase to individual sections of the non-transparent base and removing the liquid phase from the applied layer, with further coating of the front surface of the workpiece with a transparent protective layer, while the boiling point of the liquid phase is less than 180° C.,
while suspension of particles of solid organic substance in the liquid phase is applied by a method selected from the group: screen printing, flexographic printing, tampon printing, silk-screen printing, with obtaining a microstructure of at least one heat-sensitive material, particles of solid organic substance in which are oriented predominantly parallel to the plane of the surface of the base.

19. The method according to claim 18, wherein the base includes halogen-containing polymers.

20. The method according to claim 18, wherein the solid organic substance of the heat-sensitive material(s) is selected from the group: fatty aliphatic acids containing at least 13 carbon atoms; salts of fatty aliphatic acids containing at least 12 carbon atoms; alkanes containing at least 20 carbon atoms; dialkylphosphinic acids containing at least 16 carbon atoms; amides of fatty aliphatic acids containing at least 3 carbon atoms; anhydrides of fatty aliphatic acids containing at least 22 carbon atoms; fatty aliphatic alcohols containing at least 16 carbon atoms; fatty aliphatic amines containing at least 17 carbon atoms; nitriles of fatty aliphatic acids containing at least 20 carbon atoms or mixtures thereof.
